(19) United States
(12) Patent Application Publication
(10) Pub. No.: US 2024/0064228 A1
(43) Pub. Date: Feb. 22, 2024

(54) ENHANCED COMMUNICATION BETWEEN CLIENT SYSTEMS

(71) Applicant: Ram Ramesh Seshan, San Diego, CA (US)

(72) Inventor: Ram Ramesh Seshan, San Diego, CA (US)

(21) Appl. No.: 18/453,304

(22) Filed: Aug. 21, 2023

Related U.S. Application Data
(60) Provisional application No. 63/373,084, filed on Aug. 22, 2022.

(51) Int. Cl. H04M 1/72451; H04M 1/72433; G06Q 10/1093

(52) U.S. Cl. CPC H04M 1/72451; H04M 1/72433; G06Q 10/1095

(57) ABSTRACT

Aspects of the present disclosure are directed to enhanced communication between client systems. One aspect facilitates a business entity to customize the client systems of their customers. Another aspect facilitates a user to use character-based dialing. One more aspect enables customers of a business entity to manage appointments with the business entity. Another aspect facilitates users/persons to control access to their personal data. Yet another aspect enables voice messages to be provided as quick responses to incoming calls. One aspect provides for a rich text messaging service (RTMS) protocol that may be used to deliver interactive Rich Text Format (RTF) messages to smartphones providing rich user experience found in many web-based technologies.

### PRIORITY CLAIM

The instant patent application claims priority from co-pending US Provisional Patent Application entitled, “ENHANCED COMMUNICATION BETWEEN CLIENT SYSTEMS”, Ser. No. 63/373,084, Filed: 22 Aug. 2022, which is incorporated in its entirety herewith to the extent not inconsistent with the disclosure herein.

### BACKGROUND OF THE DISCLOSURE

### Technical Field

The present disclosure relates to electronic communications, and more specifically to enhanced communication between client systems.

### Related Art

Client systems such as a personal computer, workstation, mobile device, computing tablet etc., are often used by users to communicate with other users. Aspects of the present disclosure are directed to providing enhanced communication between such client systems.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which client systems are customized according to aspects of the present disclosure.

FIG. 3 depicts the manner in which entity data is maintained in a client system in one embodiment.

FIGS. 4A-4G illustrate user interfaces that may be provided as part of customizing client systems in one embodiment.

FIG. 5 is a flow chart illustrating the manner in which character-based dialing is facilitated according to aspects of the present disclosure.

FIGS. 6A and 6B together illustrate the manner in which character-based dialing is provided in one embodiment.

FIG. 7 is a flow chart illustrating the manner in which a customer of a business entity is enabled to manage appointments with the business entity according to aspects of the present disclosure.

FIG. 8 depicts the manner in which calendar data is maintained in a client system in one embodiment.

FIGS. 9A-9H illustrate user interfaces that may be provided as part of enabling customers of a business entity to manage appointments with the business entity in one embodiment.

FIG. 10 is a flow chart illustrating the manner in which users control access to their personal data according to aspects of the present disclosure.

FIGS. 11A-11D illustrate the manner in which users control access to their personal data in one embodiment.

FIG. 12 is a flow chart illustrating the manner in which voice messages are enabled to be provided as quick responses to incoming calls according to aspects of the present disclosure.

FIG. 13 illustrates the manner in which users are enabled to provide voice messages as quick responses to incoming calls in one embodiment.

FIG. 14 is a flow chart illustrating the manner in which rich text messaging service is provided according to aspects of the present disclosure.

FIG. 15A-15E together depict the details of a rich text messaging service (RTMS) message in one embodiment.

FIGS. 16A-16C together illustrate sample rich text messaging service (RTMS) messages received at a client system and corresponding interactive panels provided on the client system.

FIG. 17 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

Aspects of the present disclosure are directed to enhanced communication between client systems. According to one aspect, a client system receives, an entity data specifying one or more phone numbers associated with a business entity and a logo of the business entity. Upon determining that a user using the client system has performed an action associated with at least one phone number of the one or more phone numbers, the client system displays the logo of the business entity on a display unit associated with the client system.

In one embodiment, the action is one of receiving/placing a voice call from/to the at least one phone number, wherein the displaying displays the logo during the voice call. In another embodiment, the action is of viewing details of multiple business entities including the business entity. The client system displays one or more graphic buttons, wherein each graphic button, upon being selected, displays information about a corresponding business entity of the multiple business entities. As such, the client system displays the graphic button representing the business entity with the logo. In yet another embodiment, the action is of initiating a chat room between the user and the business entity, with the entity data also specifying a color associated with the business entity. As such, the client system customizes the chatroom with the color and the logo of the business entity.

According to another aspect of the present disclosure, the client system receives a promotional graphics associated with the business entity. In the scenarios that a logo of the business entity is to be displayed on a display unit associated with the client system, the client system displays the promotional graphics in place of the logo (of the business entity). For example, when the logo is displayed as part of a graphics button, the client system updates the graphic button representing the business entity to display the promotional graphics in place of the logo.

According to one more aspect of the present disclosure, as part of the placing a voice call to a phone number, the client system provides on the display unit, a toggle button which in a first position causes a number keypad to be displayed on the display unit and in a second position causes a character keypad to be displayed on the display unit. The number keypad enables the user to input one or more digits and the character keypad enables the user to input one or more characters, with each character in the character keypad having a mapping to a corresponding digit. Upon receiving via the number keypad, a first set of digits and via the character keypad a first set of characters, the client system identifies a second set of digits corresponding to the first set of characters based on the mapping and constructs the phone number by combining the first set of digits and the second set of digits. The user can thereafter place to call to the constructed phone number.

According to yet another aspect of the present disclosure, the client system receives calendar data specifying details of one or more time slots available in a business calendar of the business entity. The client system displaying on the display unit, an appointment widget showing the details of the one or more time slots. Upon receiving an indication to check conflicts whether the one or more time slots have any conflicts with appointments already made in a local calendar of the user, the client system determines conflicts between the one of more time slots and the appointments in the local calendar. The client system indicates, in the appointment widget, a status (no conflict, partial conflict, and direct conflict) of the conflicts between the one or more time slots and the appointments. Upon receiving a confirmation from the user to add a new appointment in a first time slot of the one or more time slots, the client system adds the new appointment in the first time slot in the business calendar of the business entity and the local calendar of the user.

According to an aspect of the present disclosure, each time slot of the one or more time slots is associated with a respective start time and a respective end time. Upon receiving, via the appointment widget, a request for an earliest time slot available in the business calendar, the client system identifies a time slot having the least respective start time that has no conflicts with the appointments as the earliest time slot.

According to another aspect of the present disclosure, the calendar data also specifies a number of walk-ins allowable for a duration. Upon receiving, via the appointment widget, a request for a walk-in in the duration, the client system identifies that the request is allowable in view of the number of walk-ins specified in the calendar data for the duration and adds a walk-in appointment for the duration in the business calendar of the business entity and the local calendar of the user.

According to one more aspect of the present disclosure, the client system maintains multiple data elements related to the user. Upon receiving, from the user, an indication that a data element is to be provided access to a second user, the client system sending to a second client system used by the second user, the details of the shared data element and enables in the second client system, the second user to perform a second action related to the shared data element. The actions of receiving, sending and enabling is performed without receiving any communication from the second user.

In one embodiment, the shared data element is a date associated with a personal event of the user, with the second action being placing a call or sending a greeting to the user. In another embodiment, the shared data element is an address associated with a location of the user, with the second action being providing to the second user, the address and directions to reach the address.

According to yet another aspect of the present disclosure, the client system stores a set of voice messages provided by the user. Upon receiving an incoming call, the client system gets from the user, a selection of a voice message from the set of voice messages and responds to the incoming call with the selected voice message.

According to an aspect of the present disclosure, a client system monitors messages received and displayed by a messaging application executing in the client system. Upon identifying, at the client system, that a first message of the messages includes one or more display instructions, the client system forms an interactive panel containing one or more display elements corresponding to the one or more display instructions and provides (e.g., displays) the interactive panel as part of a user interface provided by the messaging application. Upon receiving, at the client system via the interactive panel, one or more inputs provided by a user of the client system, the client system encodes the one or more inputs as a first reply message and sends the first reply message as a response to the first message.

According to another aspect of the present disclosure, each message (noted above) comprises an encryption flag indicating whether the message is encrypted is not, a message reason, a business entity identifier, a user identifier of the user, a message identifier, a message type, one or more action buttons, one or more attachments, an attachment type and a message content.

In one embodiment, the message reason is one of one-way origination message, a message requesting data, or the actual data received from the user; each action button contains a name, shape, color, and a universal resource locator (URL) and the message content includes the one or more display instructions according to one of rich text format (RTF) and hypertext markup language (HTML).

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

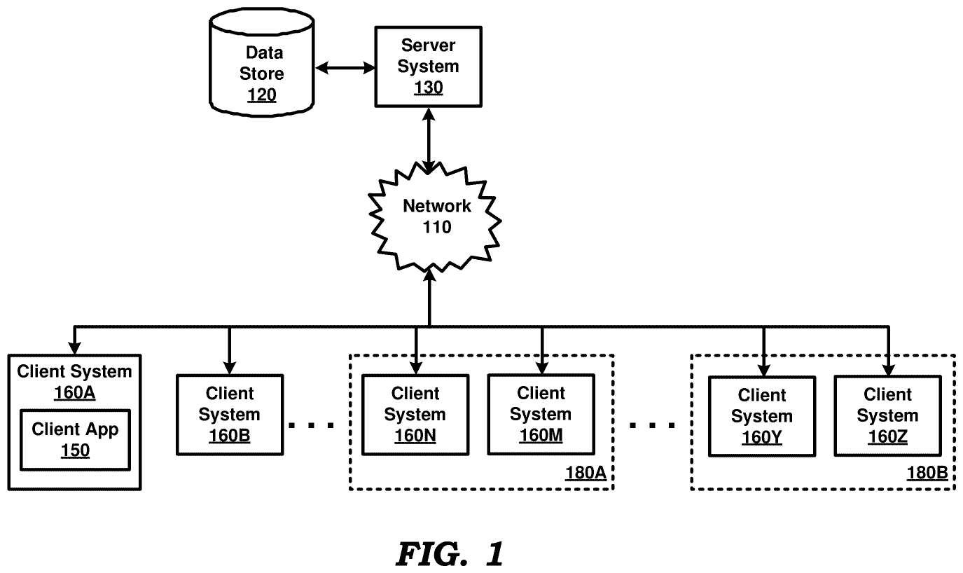

FIG. 1 is a block diagram illustrating an example environment in which several aspects of the present disclosure can be implemented. The block diagram is shown containing network 110, data store 120, server system 130, client app 150 and client systems 160A-160Z (Z being any natural number). The client systems are collectively referred to by 160.

Merely for illustration, only representative number/type of systems is shown in FIG. 1. Many environments often contain many more systems, both in number and type, depending on the purpose for which the environment is designed. Each block of FIG. 1 is described below in further detail.

Network 110 provides connectivity between server system 130 and client systems 160 and may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 110. When the packet contains content such as port numbers, which specifies the target application, the packet may be said to be directed to such application as well.

Data store 120 represents a non-volatile (persistent) storage facilitating storage and retrieval of a collection of data by applications executing in server system 130. Data store 120 may be implemented as a database server using relational database technologies and accordingly provide storage and retrieval of data using structured queries such as SQL (Structured Query Language). Alternatively, data store 120 may be implemented as a file server providing storage and retrieval of data in the form of files organized as one or more directories, as is well known in the relevant arts.

Server system 130 represents a server, such as a web/application server, constituted of appropriate hardware executing one or more software applications capable of performing tasks requested by client systems 160. Server system 130 receives a client request from a client system and performs the tasks requested in the client request. Server system 130 may use data stored internally (for example, in a non-volatile storage/hard disk within the server system), external data (e.g., maintained in data store 120) and/or data received from external sources (e.g., from the user) in performing the requested tasks. The server system then sends the result of performance of the tasks to the requesting client system (one of 160A-160Z) as a corresponding response to the client request. The results may be accompanied by specific user interfaces (e.g., web pages) for displaying the results to the requesting user.

Each of client systems 160A-160Z represents a system such as a personal computer, workstation, mobile device, smartphone, computing tablet etc., used by users to generate client requests directed to software applications executing in server system 130. The client requests may be generated using appropriate user interfaces (e.g., web pages provided by an application executing in server systems, a native user interface provided by a portion of the application downloaded from server systems, etc.).

In general, a client system requests a software application for performing desired tasks and receives the corresponding responses (e.g., web pages) containing the results of performance of the requested tasks. The web pages/responses may then be presented to the user by the client applications such as the browser. Each client request is sent in the form of an IP packet directed to the desired server system (here 130) and/or application, with the IP packet including data identifying the desired tasks in the payload portion.

Some of the client systems may be used by staff of a business entity (such as a company, business organization) to communicate with their customers using other client systems. Each of 180A and 180B represents respective set of client systems used by the staff of a corresponding business entity. In the following disclosure, the term “user” is used to referred to either to a customer or a staff of the business entity. There are several challenges in the communications between customers and business entities (in particular, their staff) using such client systems 160.

One challenge is that many business entities have several phone numbers. A business entity may use any one of these numbers to make a voice call to their customers. If their customers do not store all the phone numbers in their contacts, they may not recognize the number and hence may not answer the voice call. Additionally, the current phone system does not provide a way to display the business logo on an incoming voice call unless the logo image is also stored by the client as part of the business contact.

Another challenge is that many business entities have a need to promote their products and services to their customers. However, there is no easy way to push a promotional graphic image to their customers' client systems except by sending emails or sending expensive MMS (Multi-Media Messaging) messages (when the client systems are smartphones).

One more challenge is that many business entities have a need to directly communicate with their customers. Having a customized chatroom with the company logo and colors will greatly enhance customer experience and loyalty. Unless a business entity has their own smartphone/mobile application or white label a third-party application, it will not be possible for the business entity to customize the chatroom with their own logo, colors, and other pertinent information.

Client app 150 is a software application executing in client system 160A that enhances the communication between client systems according to several aspects of the present disclosure. Though shown executing only in client system 160A, it may be appreciated that corresponding instances of client app 150 may be executed in other client systems as well.

Client app 150, according to an aspect of the present disclosure, facilitates a business entity to customize the client systems of their customers that overcomes the drawbacks noted above. The manner in which client app 150 customizes the client systems is described below with examples.

3. Customizing Client Systems

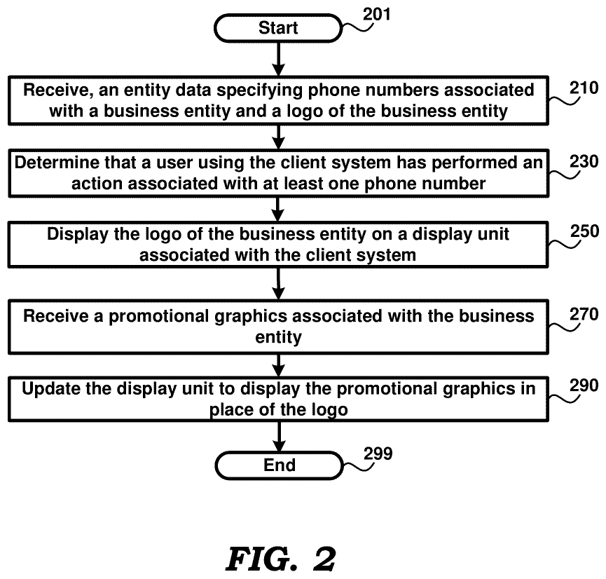

FIG. 2 is a flow chart illustrating the manner in which client systems are customized according to aspects of the present disclosure. The flowchart is described with respect to the systems of FIGS. 1, in particular client app 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, client app 150 receives at a client system (assume to be 160A), an entity data specifying phone numbers associated with a business entity and a logo of the business entity. In one embodiment, the entity data also specifies a color associated with the business entity.

The entity data may be specified according to any convenient format. The entity data may be received from another client system (such as 160M) used by a user/staff of the business entity. Alternatively, the entity data may be received from server 130, which in turn may have received the entity data from another client system 160M.

In step 230, client app 150 determines that a user using the client system (160A) has performed an action associated with at least one phone number. The action performed associated with the phone number may be one of receiving a voice call from the phone number, placing a voice call to the phone number, viewing details of multiple business entities as corresponding graphics buttons (each button on selection displaying the details of a corresponding business entity), initiating a chat room between the user and (a staff of) the business entity using the phone number.

In step 250, client app 150 displays the logo of the business entity on a display unit associated with the client system. Such display may entail displaying the logo during a voice call between the user and (a staff of) the business entity, displaying a graphic button representing the business entity with the logo when viewing details of multiple business entities, customizing a chatroom with the color and the logo of the business entity.

In step 270, client app 150 receives a promotional graphics associated with the business entity. The promotional graphics may be an image, animation, or a short video that promotes services offered by the business entity. Such promotional graphics may be received from another client system (such as 160M) or from server 130.

In step 290, client app 150 updates the display unit to display the promotional graphics in place of the logo. It may be appreciated that such update enables the user of the client system to view the promotional graphics in the place where the logo was previously displayed. In the scenario where graphics buttons corresponding to multiple business entities are displayed, such display of promotional graphics enables the business entity to stand out among the multiple business entities being displayed on the display unit. Control passes to step 299, where the flowchart ends.

Thus, client app 150 provides an automated way for business entities to store multiple phone numbers on their customer's client system. Hence, when a business entity initiates a voice call to their customers, their logo and name will be displayed for their customers to easily identify and answer the voice call. The business logo is also displayed when the user places a call to any of the phone numbers of the business entity. It may be appreciated that the display of the logo when performing associated actions enhances the user engagement with the business entity.

In addition, client app 150 provides a method for the business entities to customize their chat room with their own logo and colors, and to also show promotional graphics, animated GIF, or a short video within their chat room. Furthermore, client app 150 provides a method for the business entities to dynamically change their logo graphics button with a promotional graphics. The business entity can push the promotional graphics to all or selected customer segments and revert it at any time to their logo.

The manner in which client app 150 provides several aspects of the present disclosure according to the steps of FIG. 2 is described below with examples.

### 4. Illustrative Example for Customizing Client Systems

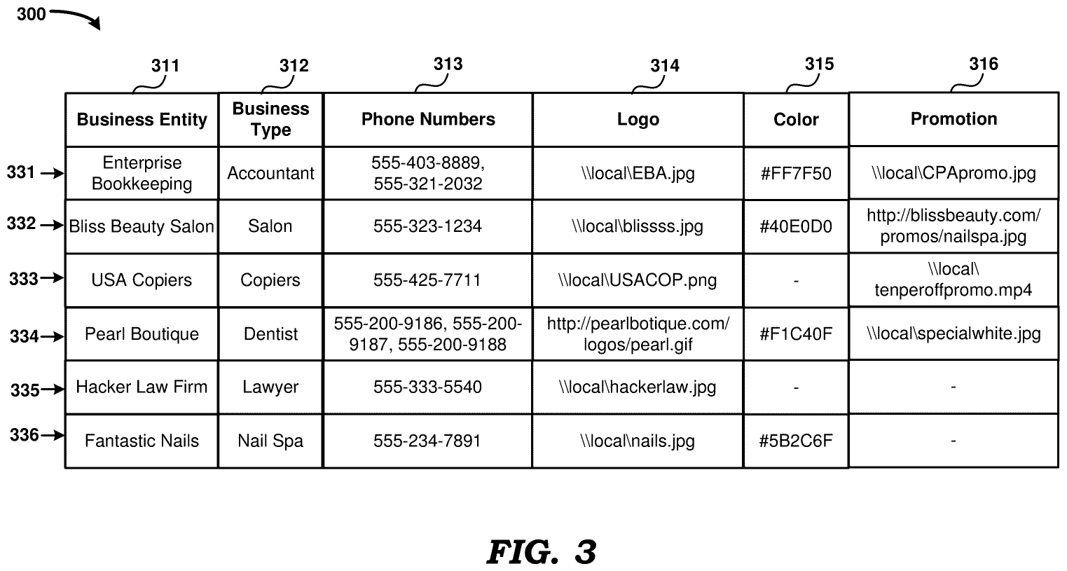

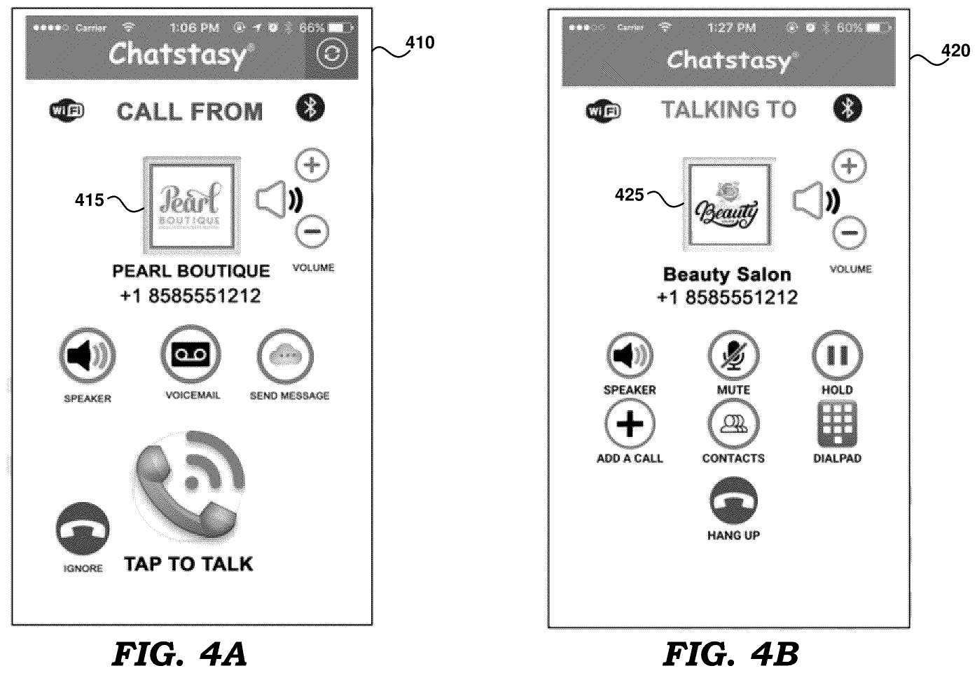

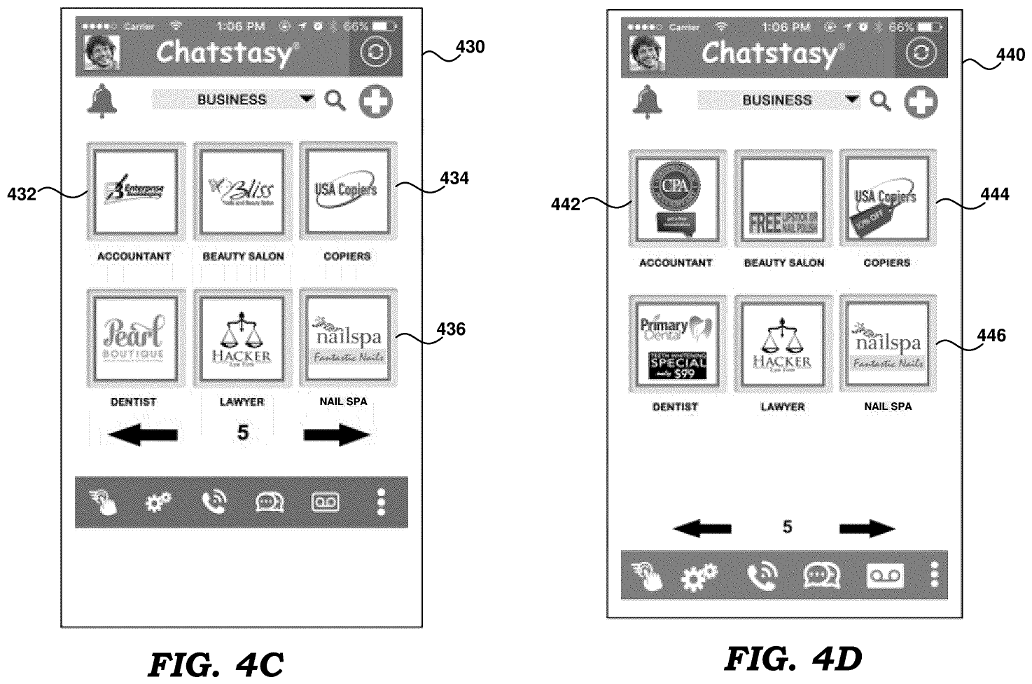

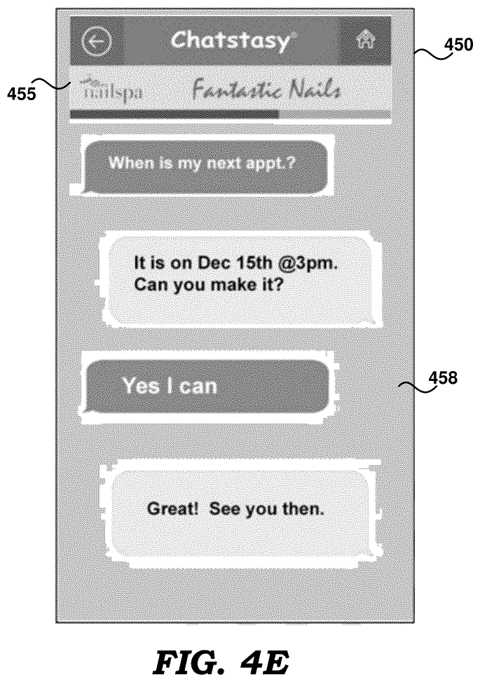

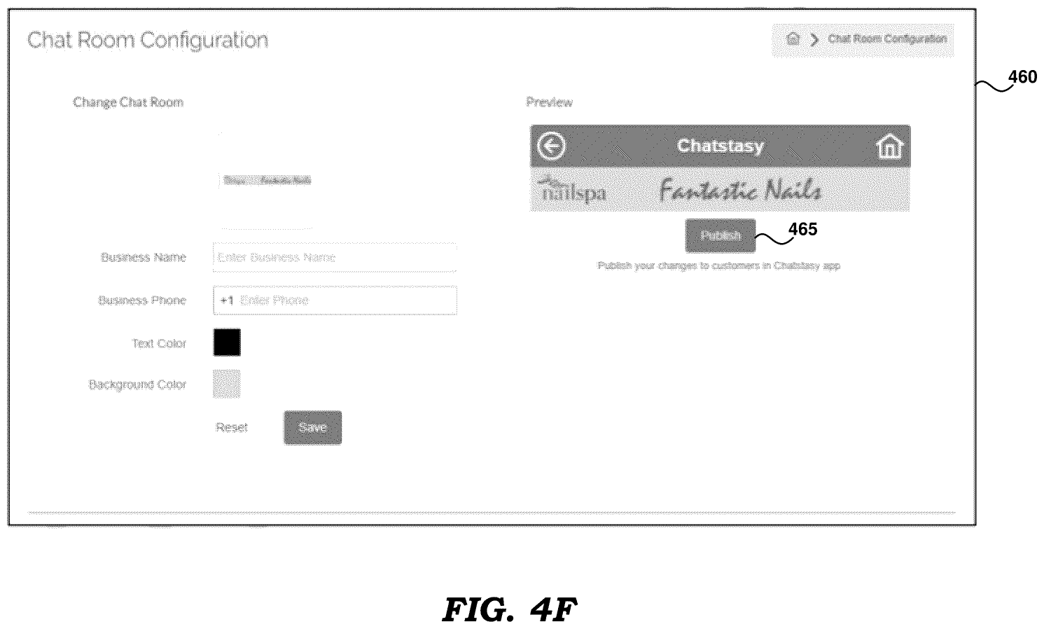

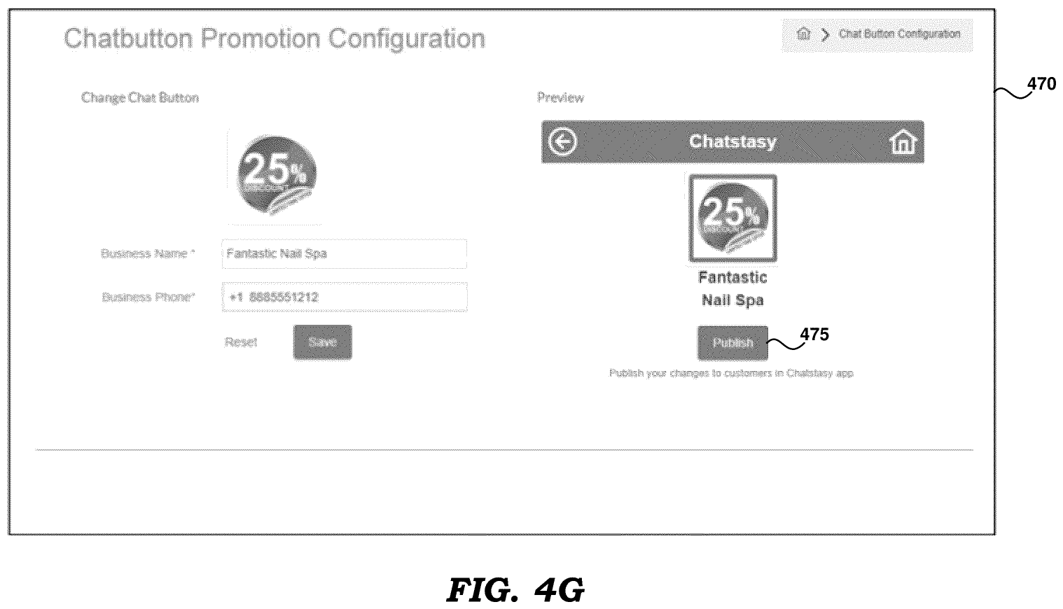

FIGS. 3 and 4A-4G illustrate the manner in which client systems are customized in one embodiment. Each of the Figures is described in detail below.

FIG. 3 depicts the manner in which entity data is maintained in a client system in one embodiment. Though shown in the form of a table (300), the entity data may be received/maintained according to other data formats (such as extensible markup language (XML), etc.) and/or using other data structures (such as lists, trees, etc.), as will be apparent to one skilled in the relevant arts by reading the disclosure herein.

Table 300 depicts the entity data maintained in client system 160A by client app 150. Table 300 may be maintained in a local data store (not shown) internal to client system 160A. Column 311 (“Business Entity”) specifies the name of a business entity, column 312 (“Business Type”) specifies a type of the business entity, column 313 (“Phone Numbers”) specifies the one or more phone numbers (separated by commas) associated with the business entity, column 314 (“Logo”) specifies a logo of the business entity either as a local file (“\\local\ . . . ”) or as a universal resource locator (URL) (“http:// . . . ”), column 315 (“Color”) specifies a color (as RGB codes) associated with the business entity, and column 316 (“Promotion”) specifies a promotional graphics received from the business entity either as a local file or as a URL.

Rows 331-336 specifies the various business entities for which the entity data is maintained. For example, row 331 specifies that the business entity with name “Enterprise Bookkeeping” is of the business type “Accountant”, has associated phone numbers “555-403-8889, 555-321-2032”, has the logo stored in “\\local\EBA.jpg”, is associated with the color “#FF7F50” and has a current promotion stored in “\\local\CPApromojpg”. Similarly, the other rows specify the details of the other business entities. The text “-” indicates that the corresponding value in not present for that combination of row and column. As such, the business entities in rows 335 and 336 do not have any promotions associated with them.

Thus, client app 150 maintains entity data related to multiple business entities in client system 160A. Client app 150 may use the entity data to provide various aspects of the present disclosure as described in detail below.

FIGS. 4A-4G illustrate user interfaces that may be provided as part of customizing client systems in one embodiment. In the following disclosure, for illustration, it is assumed that client system 160A is a smartphone and that client app 150 is a mobile application executing in the smartphone. Accordingly, the user interfaces shown hereafter are mobile user interfaces provided by client app 150 that are displayed on a display unit (touchscreen) of the smartphone.

Alternatively, the user interfaces described herein may be displayed on a display unit (not shown) associated with one of client systems 160. For example, each user interface may correspond to a web page rendered by a browser executing on the client system. The web pages may be provided by server 130 in response to a user sending appropriate requests (for example, by specifying corresponding URLs in the address bar) using the browser.

FIG. 4A illustrates a user interface provided upon receiving a voice call in one embodiment. In particular, display area 410 depicts a portion of the user interface displayed in client system 160A when a business entity (e.g., Enterprise Bookkeeping) initiates a voice call to a user using client system 160A. Upon receiving the voice call from the one or more phone numbers (e.g., 555-403-8889, 555-321-2032) associated with the business entity, client app 150 displays the logo (e.g., “\\local\EBA.jpg”) of the business entity on the display unit as illustrated by display area 415. This enables the customer to easily identify and answer the voice call from the business entity.

FIG. 4B illustrates a user interface provided upon a user placing a voice call in one embodiment. In particular, display area 420 depicts a portion of the user interface displayed in client system 160A when the user places a voice call to the one or more phone numbers (e.g., 555-403-8889, 555-321-2032) associated with a business entity (e.g., Enterprise Bookkeeping). In response, client app 150 displays the logo (e.g., “\\local\EBA.jpg”) of the business entity on the display unit as illustrated by display area 425.

FIG. 4C illustrates a user interface using which a user can view details of multiple business entities in one embodiment. In particular, display area 430 depicts a portion of the user interface displayed in client system 160A when a user wishes to view the details multiple business entities. Display area 430 is shown containing one or more graphic buttons (such as 432, 434 and 436), each graphic button, upon being selected being configured to display information about a corresponding business entity of the multiple business entities. It may be observed that display area 430 depicts 6 graphics buttons corresponding to the 6 business entities maintained in entity data of table 300 (of FIG. 3). According to an aspect, client app 150 displays each graphic button (e.g., 432) representing a business entity (e.g., Enterprise Bookkeeping) with the corresponding logo (e.g., “\\local\EBA.jpg”).

FIG. 4D illustrates a user interface displaying promotional graphics provided by business entities in one embodiment. In particular, display area 440 depicts a portion of the user interface displayed in client system 160A. Display area 440 is similar to that of display area 430, but with graphic buttons 442 and 444 updated to show promotional graphics received for the corresponding business entities instead of their corresponding logos (as shown in 432 and 434). For example, graphics button 444 corresponding to business entity “USA Copiers” is shown updated to display the promotion “\\local\tenperoffpromo.mp4” instead of the corresponding logo “\\local\USACOP.png”. It may be observed that graphics button 446 is the same as graphics button 436 as the corresponding business entity “Fantastic Nails” does not have any associated promotional graphics.

FIG. 4E illustrates a chat user interface provided when a chat room is initiated between a user and a business entity in one embodiment. In particular, display area 450 depicts a portion of the user interface displayed in client system 160A as part of the chat room initiated between the user and the business entity “Bliss Beauty Salon”. Upon the chat room being initiated, customizes the chat room by displaying the logo (“\\local\blissss.jpg”) of the business entity on the display unit as illustrated by display area 455. In addition, client app 150 also customizes the chat room with the color (#40E0D0) associated with the business entity. For example, client app 150 may set the background color of the chat room to the color associated with the business entity as indicated by display portion 458.

FIG. 4F illustrates a user interface using which a business entity specifies an associated logo and color in one embodiment. In particular, display area 460 depicts a portion of the user interface displayed in another client system (assumed to be 160M) that enables a user (e.g., a staff of the business entity) to specify the logo and color associated with the business entity. Upon the user selecting “Publish” button in display area 465, client system 160M forms and sends an entity data containing the details of the business entity, associated logo, and color to client system 160A (which in turn uses the received entity data to customize the chat room as described above with respect to FIG. 4E).

FIG. 4G illustrates a user interface using which a business entity specifying a promotional graphics in one embodiment. In particular, display area 470 depicts a portion of the user interface displayed in another client system (160M) that enables a user (e.g., a staff of the business entity) to specify a promotional graphics for the business entity. Upon the user selecting “Publish” button in display area 475, client system 160M sends the details of the business entity and the promotional graphics to client system 160A (which in turn displays the received promotional graphics as described above with respect to FIG. 4D).

Thus, client app 150 provides customized client systems according to several aspects of the present disclosure. Specifically, client app 150 displays the logo when performing actions associated with the phone numbers of business entities, facilitates the business entities to customize their chat room with their own logo and colors and facilitates the business entities to dynamically change their logo graphics button with a promotional graphics.

An additional challenge with the communications between client systems is that when a user wishes to dial a desired phone number, conventional smartphones only display a numeric dial pad showing buttons/keys corresponding to digits (0 to 9). Each button/key is also associated with multiple alphabets/characters (e.g., the button for digit 2 is typically associated with the alphabets A, B and C). If a user needs to dial 1-800-FLOWERS (typically of a business entity), the user needs to select the appropriate number equivalent to the corresponding characters from the numeric dial pad. This could be time consuming and error prone. In some scenarios (e.g., 1-800-ALASKAAIR), the characters are much longer than the digits used for dialing.

Client app 150, according to an aspect of the present disclosure, facilitates character-based dialing that overcomes the drawbacks noted above. The manner in which client app 150 facilitates character-based dialing is described below with examples.

5. Facilitating Character-Based Dialing

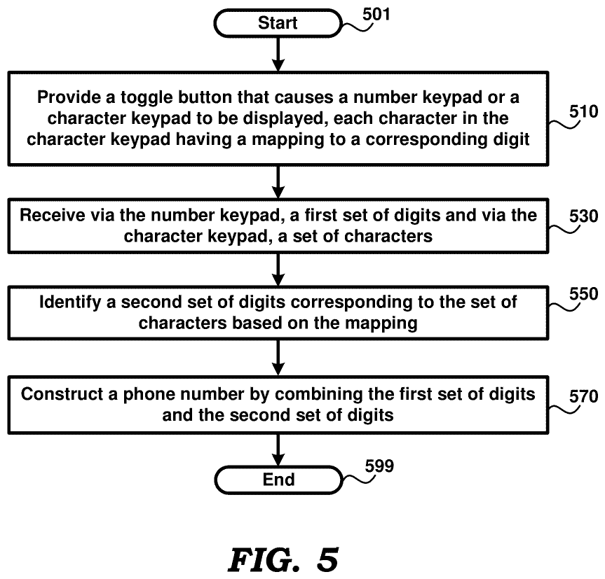

FIG. 5 is a flow chart illustrating the manner in which character-based dialing is facilitated according to aspects of the present disclosure. The flowchart is described with respect to the systems of FIGS. 1, in particular client app 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 501, in which control immediately passes to step 510.

In step 510, client app 150 provides, on a display unit, a toggle button that causes a number keypad or a character keypad to be displayed, each character in the character keypad having a mapping to a corresponding digit. Specifically, when the toggle button is in a first position, client app 150 displays, on the display unit, a number keypad which enables a user to input one or more digits. When the toggle button is in a second position, client app 150 displays, on the display unit, a character keypad which enables the user to input one or more characters.

In step 530, client app 150 receive via the number keypad, a first set of digits and via the character keypad, a set of characters. The inputs are received from a user using client app 150.

In step 550, client app 150 identifies a second set of digits corresponding to the set of characters based on the mapping. As each character is mapped to a single digit, such identification may be performed in a known way, for example, using a simple list of values (e.g., A=2, B=2 . . . Z=9), as will be apparent to one skilled in the relevant arts.

In step 570, client app 150 constructs a phone number by combining the first set of digits and the second set of digits. The user may thereafter place a call to/dial the constructed phone number. Control passes to step 599, where the flowchart ends.

Thus, client app 150 provides a character keyboard for the user to directly type the letters. Client app 150 enables a user to switch between a number keypad and the character keypad when dialing a phone number containing digits and characters. In the character keyboard, the characters will be clearly displayed on the screen for the user to see and correct if required.

The manner in which client app 150 provides several aspects of the present disclosure according to the steps of FIG. 5 is described below with examples.

### 6. Illustrative Example for Character-Based Dialing

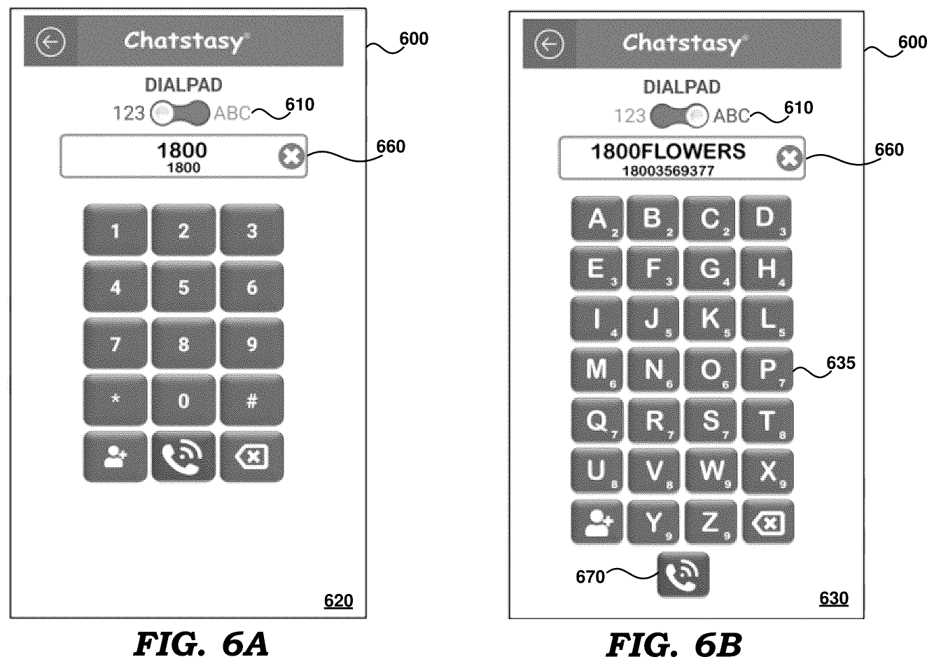

FIGS. 6A and 6B together illustrate the manner in which character-based dialing is provided in one embodiment. Display area 600 depicts a portion of the user interface displayed when a user wishes to dial a desired phone number (for example, a phone number associated with a business entity) such as 1-800-FLOWERS.

Referring to FIG. 6A, toggle button 610 is shown set to a first position (indicated by “123”). As such, client app 150 displays a number keypad on the display unit as shown in display area 620. The user may accordingly use the number keypad to enter/input a first set of digits (here, 1800) as shown in display area 660.

Referring to FIG. 6B, toggle button 610 is shown set to a second position (indicated by “ABC”). As such, client app 150 displays a character keypad on the display unit as shown in display area 630. It may be observed that each character button/key (such as “P” in display area 635) in the character keypad is shown associated with a corresponding number (number 7 in display area 635). The user may accordingly use the number keypad to enter/input a set of characters (here, FLOWERS) as shown in display area 660.

Client app 150 also identifies a second set of digits (here, 3569377) corresponding to the entered set of characters and then constructs a phone number (here, 18003569377) by combining the first and second sets of digits. The constructed phone number is displayed in display area 660 below the first set of digits and the set of characters input by the user. The user may thereafter select/click/touch the dial button shown in display area 670 to dial/place a call to the constructed phone number.

Thus, client app 150 provides character-based dialing according to several aspects of the present disclosure. Specifically, upon selecting the dial button (670), the characters input by the user is automatically mapped to the respective number equivalent, and the call is placed. Such a feature may be specifically desirable when the smartphone (client system 160A) is used by elderly people or by people with disabilities.

An additional challenge with the communications between client systems is that many small businesses entities have a difficult time finding staff to manage their front office or they cannot afford to recruit any additional staff to manage their front office. One of the many tasks of the front office is to provide information about their services, book new appointments and manage existing appointments. Empowering their customers to make their own appointments or manage their appointments will greatly help these small business entities.

Client app 150, according to an aspect of the present disclosure, enables customers of a business entity to manage appointments with the business entity while overcoming the drawbacks noted above. The manner in which client app 150 enables customers to manage appointments with a business entity is described below with examples.

7. Managing Appointments with a Business Entity

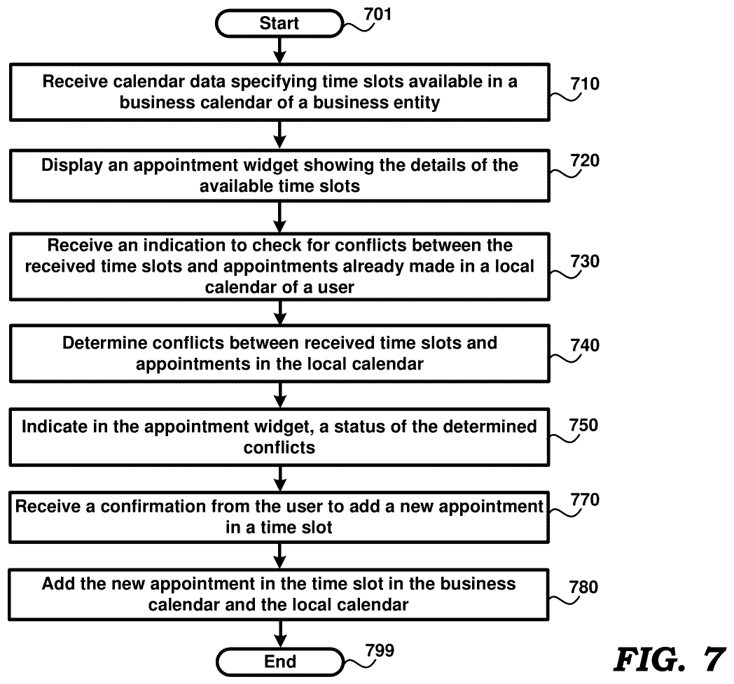

FIG. 7 is a flow chart illustrating the manner in which a customer of a business entity is enabled to manage appointments with the business entity according to aspects of the present disclosure. The flowchart is described with respect to the systems of FIGS. 1, in particular client app 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 701, in which control immediately passes to step 510.

In step 710, client app 150 receives calendar data specifying one or more time slots available in a business calendar of a business entity. Each time slot typically is associated with a respective start time and a respective end time, and thus specifies a corresponding duration.

The calendar data may be specified according to any convenient format. The calendar data may be received from another client system (such as 160M) used by a user/staff of the business entity. Alternatively, the calendar data may be received from server 130, which in turn may have received the calendar data from another client system 160M.

In step 720, client app 150 displays an appointment widget showing the details of the available time slots. Any convenient user interface may be used to display the available time slots. In the disclosure herein, the time slots are displayed as part of a calendar user interface.

In step 730, client app 150 receives an indication to check for conflicts between the received time slots and appointments already made in a local calendar of a user. The details of the already made appointments in the local calendar may be maintained in a local data store internal to the client system (here, 160A). Each already made appointment also typically is associated with a respective start time and a respective end time, and specifies a corresponding duration.

In step 740, client app 150 determine conflicts between received time slots and appointments in the local calendar. A conflict is determined to be present if the duration of a received time slot has an overlap with a duration of an already made appointment. It should be noted that there may be multiple such conflicts based on the overlaps in the durations of the received time slots and the durations of the already made appointments.

In 750, client app 150 indicates in the appointment widget, a status of the determined conflicts. In one embodiment, the status is indicated for each available time slot received from the business entity. According to an aspect, the status is one of no conflict, partial conflict, and direct conflict for each available time slot. The status “no conflict” indicates that the duration of the available time slot has no overlap with the duration of all of the appointments. The status “partial conflict” indicates that the duration of the available time slot has some overlap (the start time of time slot is greater than or less than the start time of appointment) with the duration of at least one appointment. The status “direct conflict” indicates that the duration of the available time slot has complete overlap (start times and end times are the same) with the duration of at least one appointment.

In step 770, client app 150 receives a confirmation from the user to add a new appointment in a specific time slot. It may be noted that the status of the specific time slot may be one of no conflict, partial conflict, and direct conflict.

In step 780, client app 150 adds the new appointment in the specific time slot in the business calendar and the local calendar. Such adding may entail sending a request for addition of the new appointment to the (client system of the) business entity and receiving a confirmation of addition of the new appointment. In addition, client app 150 also adds the new appointment to the local calendar maintained in client system 160A. Control passes to step 799, where the flowchart ends.

Thus, client app 150 provides an appointment calendar widget on the client system (160A) that can empower customers of a small business entity to make new appointments. Client app 150 may similarly provide the customers with the ability to change and/or to cancel their existing appointments. For the customers of a business entity, the calendar widget will show available time slots for a given service, so that the customers can easily tap on it to make an appointment. The appointment widget will also automatically check the calendars of the user for any potential conflicts before making the appointment. Upon confirmation, the new appointment is automatically inserted on user's device calendar and optionally on any other another user's device calendar (if applicable).

According to an aspect, client app 150 receives, via the appointment widget, a request for an earliest time slot available in the business calendar. Client app 150 then identifies a time slot having the least respective start time that has no conflicts with all of the already made appointments as the earliest time slot.

According to another aspect, the calendar data also specifies a number of walk-ins allowable for a duration. Upon receiving, via the appointment widget, a request for a walk-in in the duration, client app 150 identifies that the request is allowable in view of the number of walk-ins specified in the calendar data for the duration and adds a walk-in appointment for the duration in the business calendar of the business entity and the local calendar of the user.

The manner in which client app 150 provides several aspects of the present disclosure according to the steps of FIG. 7 is described below with examples.

### 8. Illustrative Example for Managing Appointments

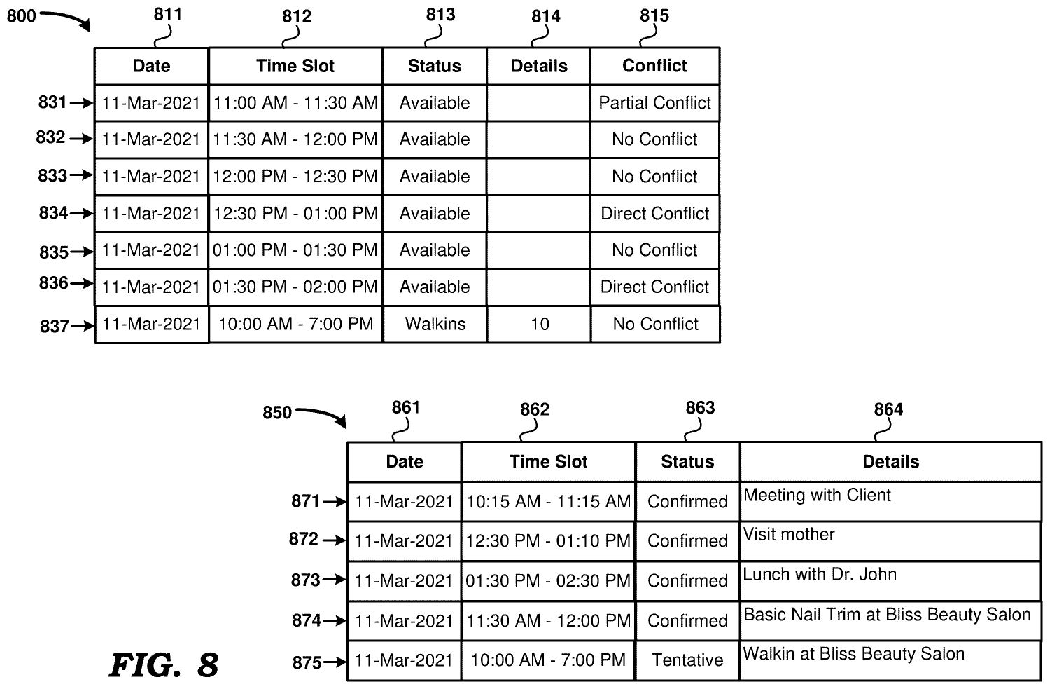

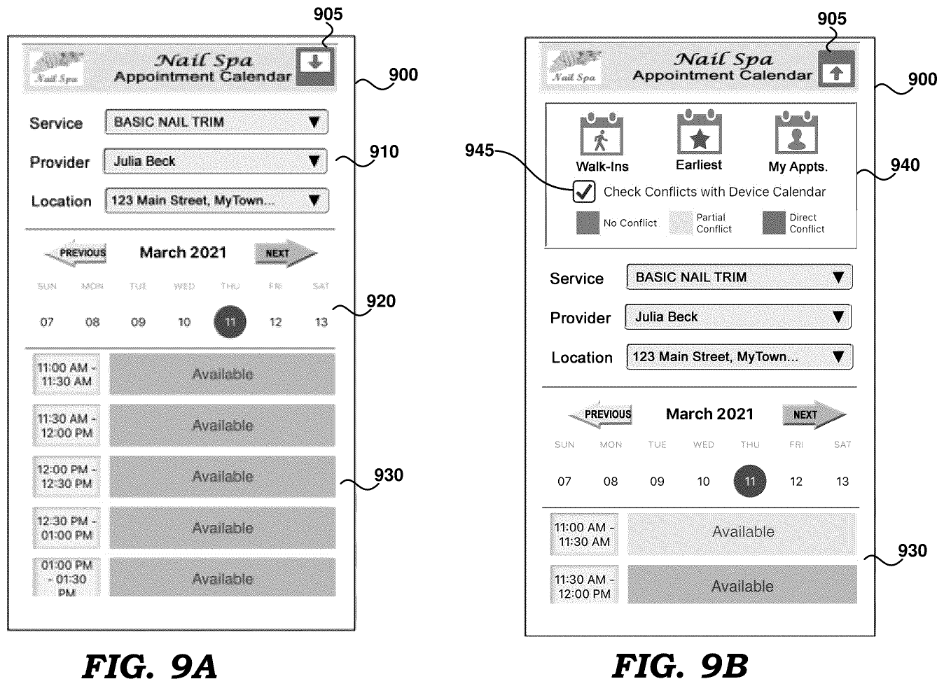

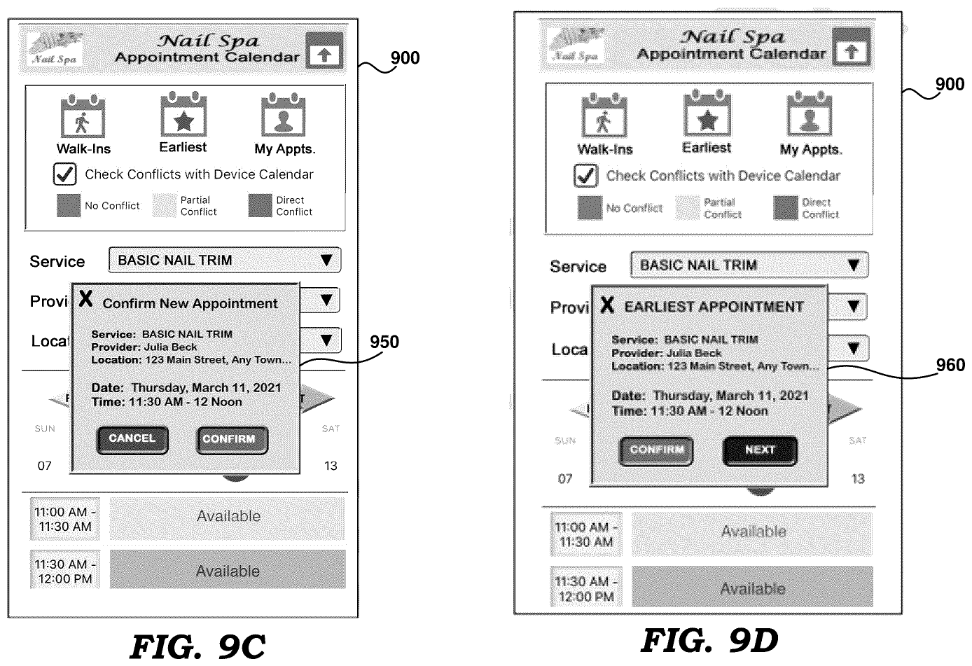

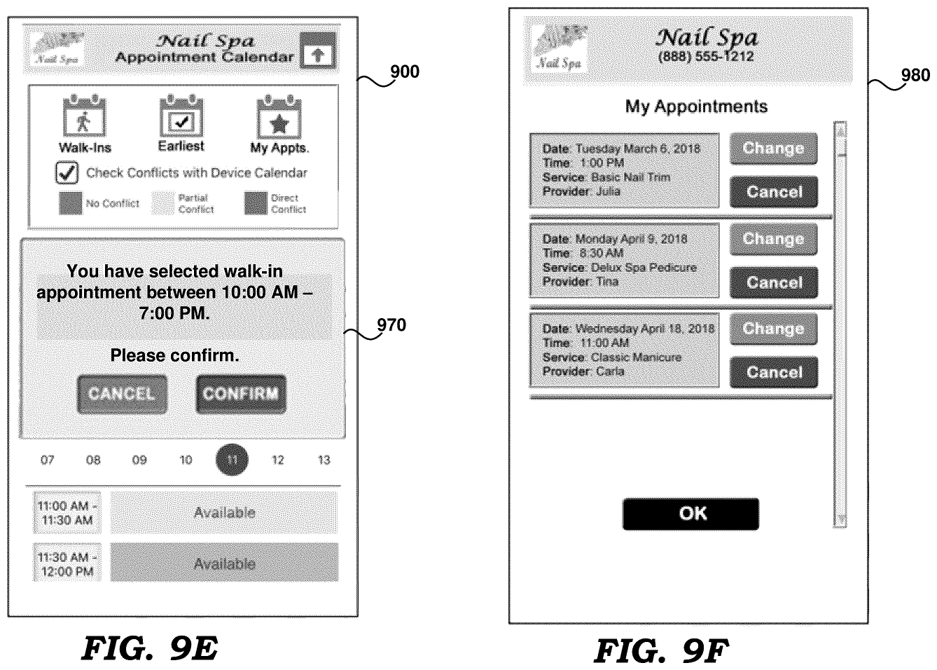

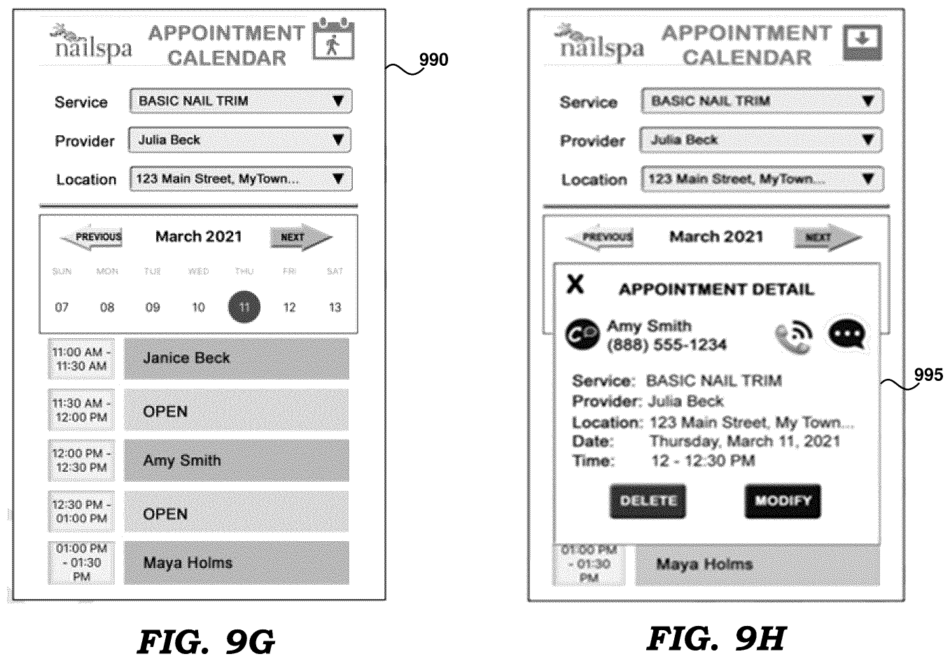

FIGS. 8 and 9A-9H illustrate the manner in which a customer of a business entity is enabled to manage appointments with the business entity in one embodiment. Each of the Figures is described in detail below.

FIG. 8 depicts the manner in which calendar data is maintained in a client system in one embodiment. Though shown in the form of a table (800/850), the calendar data may be received/maintained according to other data formats (such as extensible markup language (XML), etc.) and/or using other data structures (such as lists, trees, etc.), as will be apparent to one skilled in the relevant arts by reading the disclosure herein.

Table 800 depicts the calendar data specifying one or more time slots available in a business calendar of a business entity that is received from another client system (160M) or from server 130. Table 850 depicts appointments already made in a local calendar of a user. Both of tables 800 and 850 may be maintained by client app 150 in a local data store (not shown) internal to client system 160A.

Column 811/861 (“Date”) specifies the date for a time slot/appointment, column 812/862 (“Time Slot”) specifies respective start time and end time for the time slot/appointment, column 813/863 (“Status”) specifies a status for the time slot/appointment and column 814/864 (“Details”) specifies the details associated with the time slot/appointment. In addition, column 815 (“Conflict”) in table 800 specifies the status of the conflict for the time slot.

Referring to table 800, rows 831-836 specifies the various time slots available in a business calendar of a business entity, while row 837 specifies a number of walk-ins allowable (in “Details” column) for corresponding duration. Referring to table 850, rows 871-873 specifies the appointments already made in a local calendar of a user, while rows 874 and 875 specify new appointments created using the appointment widget. It should be noted that the status of the conflict in column 815 is shown with respect to rows 871-873, and may be updated after the addition of rows 874 and 875 (not shown).

Thus, client app 150 maintains calendar data related to a business entity in client system 160A. Client app 150 may use the calendar data to provide various aspects of the present disclosure as described in detail below.

FIGS. 9A-9H illustrate user interfaces that may be provided as part of enabling customers of a business entity to manage appointments with the business entity in one embodiment. Each of the Figures is described in detail below.

FIG. 9A illustrates an appointment widget showing the details of the available time slots in one embodiment. In particular, display area 900 depicts a portion of the user interface displayed in client system 160A. Display area 910 displays various filters for the available time slots, display area 920 displays a calendar, and display area 930 displays the time slots available in a business calendar of a business entity (here, “Bliss Beauty Salon”).

The user may select desired values in the filters (service, provider, location) shown in display area 910 and may select a desired date in display area 920. In response to such selections, client app 150 determines and displays in display area 930, only those available time slots that are applicable for the combination of the selected values and the selected date. In other words, the time slots in display are 930 are those available on Mar. 11, 2021 (selected in display area 920) and that are applicable for the service “BASIC NAIL TRIM”, provider “Julia Beck” and location “123 Main Street, My Town . . . ”. Display area 905 enables the user to view conflicts and add new appointments as described in detail below.

FIG. 9B illustrates an appointment widget showing the status of conflicts in one embodiment. In particular, display area 940 depicts a portion of the user interface displayed (roll-down) in response to the user selecting (clicking/touching) display area 905 in FIG. 9A. The user may select display area 905 again to cause display area 940 to be not displayed (roll-up). In display area 940, the user may select checkbox 945 to cause client app 150 to check for conflicts with device calendar (local calendar of the user). Display area 930 is accordingly shown with the available time slots and the status of conflict for each available time slot.

FIG. 9C illustrates an appointment widget showing the manner in which a user is enabled to add a new appointment in one embodiment. In particular, display area 950 depicts a portion of the user interface displayed in client system 160A when a user selects one of the time slots in display are 930. The user may select the “Confirm” button to cause client app 150 to send a request to the business entity (here, “Bliss Beauty Salon”) for adding the new appointment in the selected time slot. Upon receiving from the business entity, confirmation of addition of new appointment in the business calendar of the business entity, client app 150 adds the new appointment to the local calendar of the user.

FIG. 9D illustrates an appointment widget showing the earliest appointment in one embodiment. In particular, display area 960 depicts a portion of the user interface displayed in client system 160A when a user selects the “Earliest” icon in display area 940 of FIG. 9B. Upon selection of the “Earliest” icon, client app 150 identifies an earliest time slot having the least respective start time that has no conflicts with the appointments. For the data of FIG. 8, client app 150 identifies the time slot “11:30 AM −12 PM”, as it has the least start time among the time slots having no conflict status (in column 815). The user may select the “Confirm” button to cause client app 150 to add the new appointment to both the business calendar of the business entity (here, “Bliss Beauty Salon”) and the local calendar of the user. Row 874 of table 850 represent the new appointment (in the earliest time slot) added by client app 150 to the local calendar of the user.

FIG. 9E illustrates an appointment widget showing a walk-in appointment in one embodiment. In particular, display area 970 depicts a portion of the user interface displayed in client system 160A when a user selects the “Walk-Ins” icon in display area 940 of FIG. 9B. Upon selection of the “Walk-Ins” icon, client app 150 identifies that the walk-in request is allowable in view of the number of walk-ins specified in the calendar data for the duration (here, the day 11 Mar. 2021). Specifically, a walk-in request is deemed to be allowable only when the number of walk-ins for the duration is greater than 0. For the data of FIG. 8, client app 150 identifies that the number of walk-ins (10) for the duration 10:00 AM −7:00 PM on 11 Mar. 2021 is greater than 0, and accordingly shows the display area 970. The user may select the “Confirm” button to cause client app 150 to add a walk-in appointment to both the business calendar of the business entity (here, “Bliss Beauty Salon”) and the local calendar of the user. Row 875 of table 850 represent the walk-in appointment (for the duration) added by client app 150 to the local calendar of the user.

FIG. 9F illustrates an appointment widget showing a list of appointments made between a user and a business entity in one embodiment. In particular, display area 980 depicts a portion of the user interface displayed in client system 160A when a user selects the “My Appts” icon in display area 940 of FIG. 9B. Display area 980 displays a list of existing appointments made by the user with a business entity (here, “Bliss Beauty Salon”). The user may select “Change” button shown associated with an existing appointment to modify the details (such as start time and end time) of the existing appointment, or may select “Cancel” button to cancel the existing appointment.

FIG. 9G illustrates an appointment widget showing the appointments in a business calendar of a business entity in one embodiment. In particular, display area 990 depicts a portion of the user interface displayed in another client system (assumed to be 160M) that enables a user (e.g., a staff of the business entity) to view the appointments added by the customers to the business calendar of the business entity. Display area 990 is similar to display area 900 and enables the user/staff to filter the appointments by selecting desired filters and desired date. The names of the customers are shown in the appointments.

FIG. 9H illustrates an appointment widget showing the details of an appointment in a business calendar of a business entity in one embodiment. In particular, display area 995 depicts a portion of the user interface displayed in another client system (160M) that enables a user (e.g., a staff of the business entity) to view the details of an appointment added by the customers to the business calendar of the business entity. Display area 995 may be displayed in response to the user/staff selecting an appointment in display area 990. The user/staff may select “Modify” button to modify the details (such as start time and end time) of the existing appointment, or may select “Delete” button to cancel the existing appointment.

Thus, client app 150 provides an appointment widget that enables customers of a business entity to manage appointments with the business entity. The widget also enables the customers to search and book an appointment for a specific service, search and book an appointment by a specific service provider, search and book an appointment at a specific location, signup for a walk-in appointment, book an appointment for another member of the family, optionally signup for an automatic notification when there is a cancellation, and review existing appointments and make changes. For the business entity, the appointment widget shows all the booked appointment slots with customer names, phone numbers, etc.

An additional challenge with the communications between client systems is that current approaches require a user/person to remember another person's birthday, anniversary, and other special occasions. Users are required to explicitly store this information as part of the Contacts (in their smartphone) and remember to send them a greeting at the appropriate date. Users may add reminders for such dates, but the onus is on the sender of the greeting. Similarly, the user has to remember a friend or a family member's home address and get directions. User are required to explicitly store this information as part of the Contacts and remember to use them when needed. The friend or family member does not have any control over this data to make changes or prevent access.

Client app 150, according to an aspect of the present disclosure, facilitates users/persons to control access to their personal data while overcoming the drawbacks noted above. The manner in which client app 150 enables users to control access is described below with examples.

9. Controlling Access to Personal Data

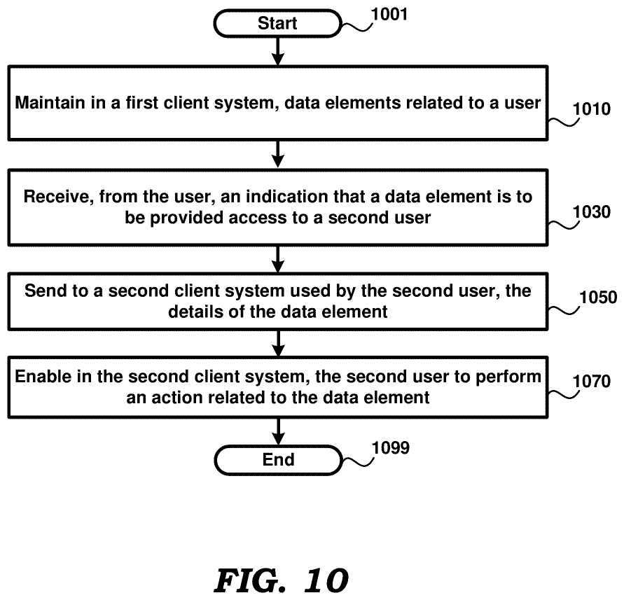

FIG. 10 is a flow chart illustrating the manner in which users control access to their personal data according to aspects of the present disclosure. The flowchart is described with respect to the systems of FIGS. 1, in particular client app 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 1001, in which control immediately passes to step 1010.

In step 1010, client app 150 maintains in a first client system (160A), data elements related to a user (personal data). Such personal data may include, but not limited to, birthday, anniversary date, home address, office address, etc. The personal data may be maintained in a local data store (not shown) internal to client system 160A.

In step 1030, client app 150 receives, from the user, an indication that a data element is to be provided access to a second user (recipient). The indication may be received in any convenient format. In one embodiment noted below, the user specifies a group of users (that includes the second user) for whom each data element is to be provided access. The user may specify desired groups and corresponding access to data elements.

In step 1050, client app 150 sends to a second client system used by the second user, the details of the data element. The second client system may be a smartphone (corresponding to client system 160B) used by another user/person or may be a client system (160M) used by a user/staff of a business entity. In the following disclosure, the data element sent to the second client system is referred to as a shared data element.

In step 1070, client app 150 enables in the second client system, the second user to perform an action related to the shared data element. In one embodiment, the shared data element is a date associated with a personal event (birthday, anniversary, etc.) of the user, wherein the action is one of placing a call or sending a greeting to the user. In another embodiment, the shared data element is an address associated with a location (home, office) of the user, wherein the action is providing to the second user, the (shared) address and directions to reach the address. Control passes to step 1099, where the flowchart ends.

It should be noted that the steps of receiving (1030), sending (1050) and enabling (1070) is performed without receiving any communication from the second user. In other words, the user is facilitated to control access to their personal data, without requiring any requests from other users.

Thus, client app 150 provides a way for users to store their personal events and control access (for recipients) to such personal events. On and/or before the date of an event, the recipient users get a notification. The recipient users can then make a call or send an automated greeting to the user who shared the special occasion event. Client app 150 also provides a way for users to store their locations and provide access to specific persons. When access is provided, recipient users are enabled to get directions to the location of the user.

The manner in which client app 150 provides several aspects of the present disclosure according to the steps of FIG. 10 is described below with examples.

### 10. Illustrative Example for Controlling Access

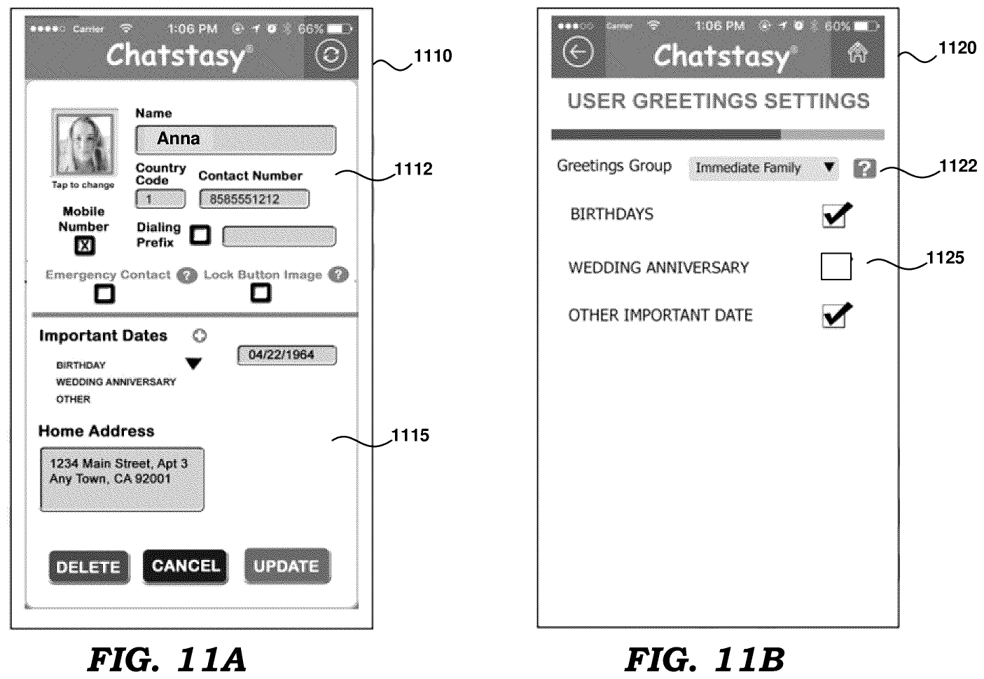

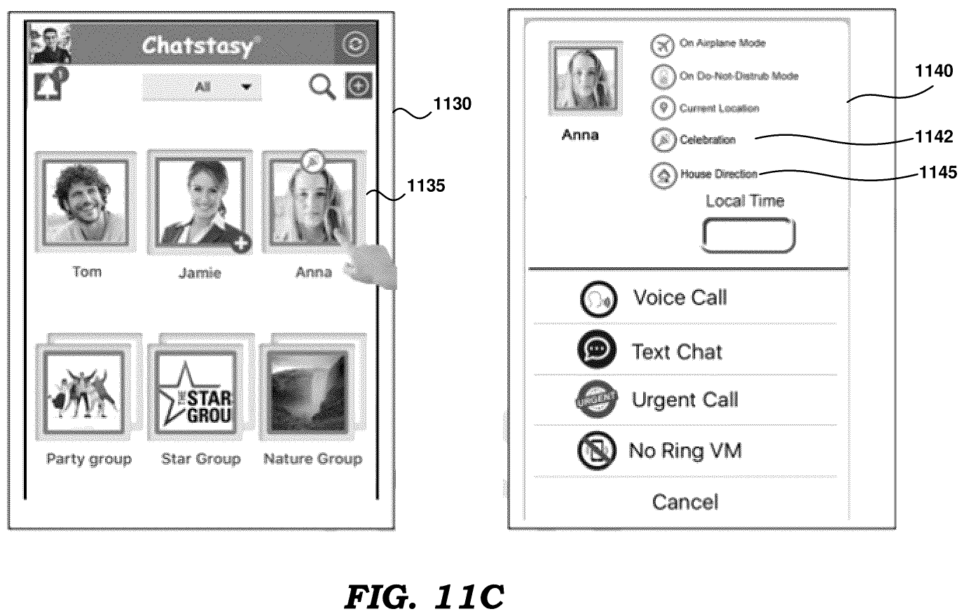

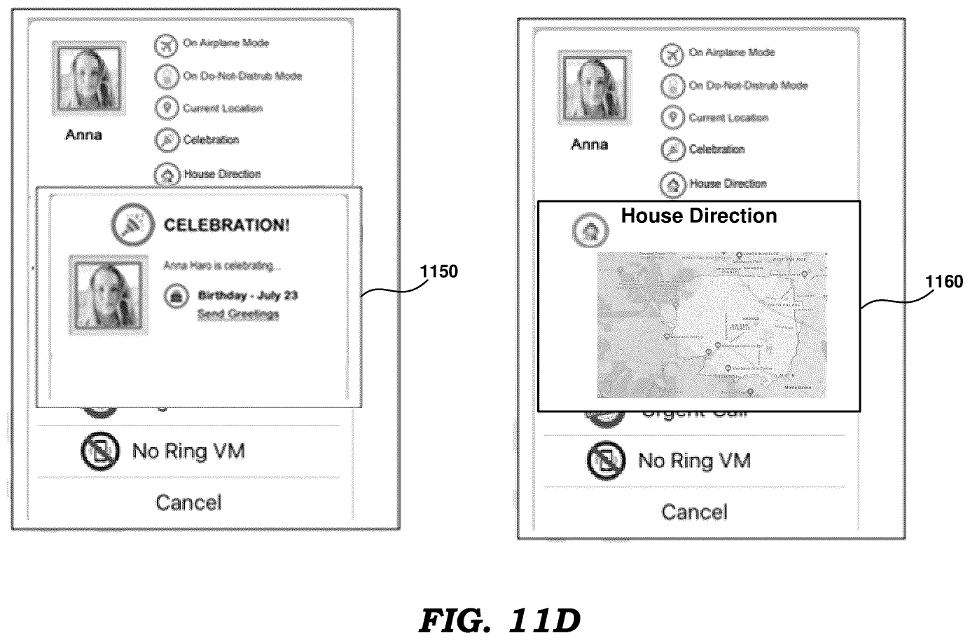

FIGS. 11A-11D illustrate the manner in which users control access to their personal data in one embodiment. Each of the Figures is described in detail below.

FIG. 11A illustrates a user interface using which a user is enabled to specify their personal data in one embodiment. In particular, display area 1110 depicts a portion of the user interface displayed in client system 160A that enables a user to specify a self-profile that includes their personal data. Display area 1112 enables the user to specify their name (here “Anna”) and a profile picture, while display area 1115 enables the user to specify their personal dates associated with events such as a birthday, wedding anniversary, etc. Display area 1115 also enables the user to specify a location (Home Address) related to the user.

FIG. 11B illustrates a user interface using which a user is enabled to control access to their personal data in one embodiment. In particular, display area 1120 depicts a portion of the user interface displayed in client system 160A that enables a user to specify the access to be provided to various groups of users. Display area 1122 enables the user to select a desired group of users, while display area 1125 enables the user to specify the specific data elements to be shared with the selected group. A ticked/selected checkbox (such as for “Birthdays”) in display area 1125 indicates that the corresponding data element is to be shared with the selected group, while the absence of the selection (such as for “Wedding Anniversary”) indicates that the corresponding data element is not to be shared with the selected group.

FIG. 11C illustrates user interfaces using which a second user (recipient) is enabled to view the profile of a user in one embodiment. In particular, display area 1130 depicts a portion of the user interface displayed in a second/another client system (assumed to be 160B). Display area 1130 shows the contacts of the second user, including the user “Anna” in display aera 1135. The second user may select (click or touch) display area 1135 to view the profile of the user.

Display area 1140 depicts a portion of the user interface displayed in the second client system 160B when the second user selects display area 1135. Display area 1140 displays the profile of the user “Anna”. Display area 1142 “Celebration” indicates that the user “Anna” has shared a date associated with a personal event with the second user, while display area 1145 “House Direction” indicates that the user “Anna” has shared an address of a personal associated with a location with the second user.

FIG. 11D illustrates user interfaces using which a second user (recipient) is enabled to perform actions related to data elements shared by a user in one embodiment. In particular, display area 1150 depicts a portion of the user interface displayed in the second client system 160B when the second user selects display area 1142 of FIG. 11C. Display area 1150 enables the second user to send a greeting to the user for the shared date. Display area 1160 depicts a portion of the user interface displayed in the second client system 160B when the second user selects display area 1145 of FIG. 11C. Display area 1160 enables the second user to view the address and directions to the shared location of the user.

Thus, client app 150 facilitates users to control access to their personal data according to several aspects of the present disclosure. Such access control may specifically be desirable when the users are sharing their personal data with business entities.

An additional challenge with the communications between client systems is that many client systems (such as smartphones) have a feature to send a pre-defined message to an incoming voice call (hereinafter referred to as “quick response”). Such a feature also can be used when the user in on another voice call. Such quick responses are generally text-based and in English language such as “I will call you shortly”, “I am on another call”, “Please call me later”, etc. However, there is no ability to send a voice-based quick response to another party.

Client app 150, according to an aspect of the present disclosure, enables voice messages to be provided as quick responses to incoming calls as described below with examples.

11. Providing Voice Messages as Quick Responses to Incoming Calls

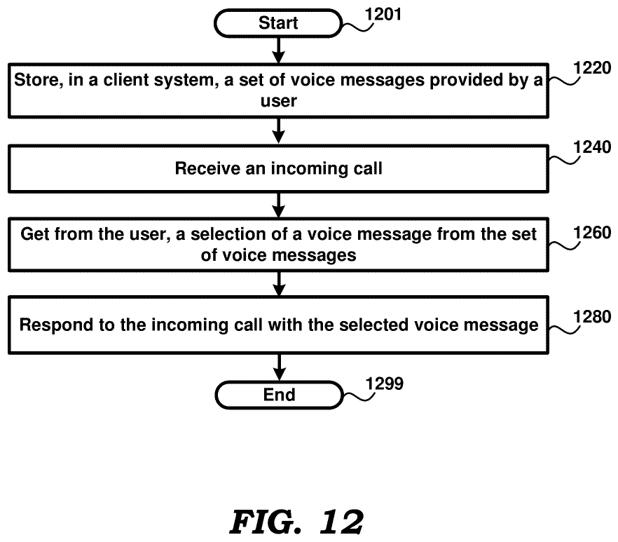

FIG. 12 is a flow chart illustrating the manner in which voice messages are enabled to be provided as quick responses to incoming calls according to aspects of the present disclosure. The flowchart is described with respect to the systems of FIGS. 1, in particular client app 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 1201, in which control immediately passes to step 1220.

In step 1220, client app 150 store, in a client system (160A), a set of voice messages provided by a user. The voice/audio messages may be recorded by the user using a microphone internal to client system 160A. The voice messages may be stored in a local data store (not shown) internal to client system 160A.

In step 1240, client app 150 receives an incoming call, for example, from a user/staff of a business entity. In step 260, client app 150 gets from the user, a selection of a voice message from the set of voice messages. In one embodiment, in response to the incoming call, client app 150 displays the set of voice messages on a display unit associated with client system 160A, thereby enabling the user to select a desired voice message to be provided as a quick response to the incoming call.

In step 1280, client app 150 responds to the incoming call with the selected voice message.

In one embodiment, such responding entails sending the selected voice message as an audio file to a second client system from which the incoming call was placed, and playing the audio file in the second client system. Alternatively, such responding may entail connecting the incoming call and playing the selected voice message in the client system during the connected call. Control passes to step 1299, where the flowchart ends.

Thus, client app 150 enables voice messages to be provided as quick responses to incoming calls. Client app 150 provides a feature to record short pre-defined voice messages, which can then be sent to the other party similar to quick text messages. When a user wants to activate this feature, they can record a short voice message corresponding to the pre-defined message and store it. When the user is on a call or does not want to pick-up a call, the user has the option of sending a desired pre-defined voice message.

The manner in which client app 150 provides several aspects of the present disclosure according to the steps of FIG. 12 is described below with examples.

### 12. Illustrative Example for Voice Messages as Quick Responses

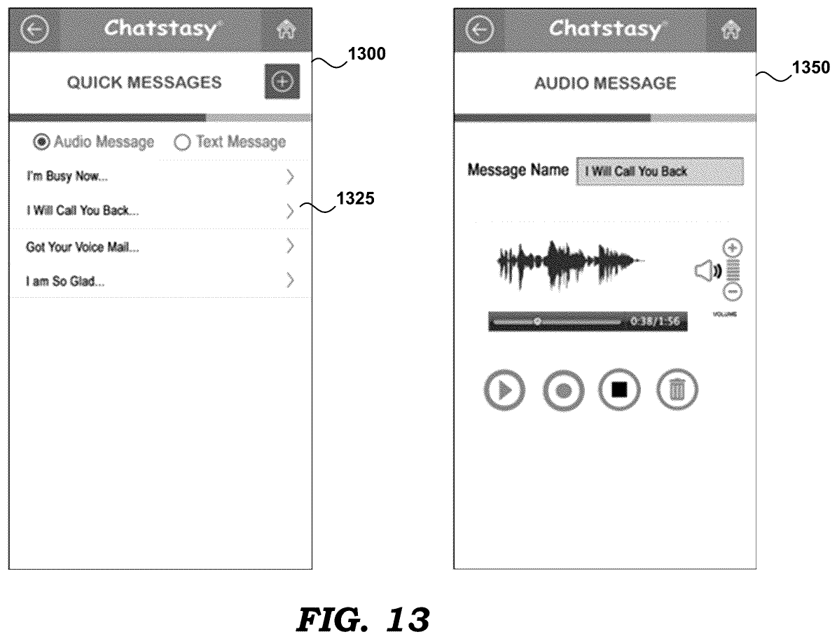

FIG. 13 illustrates the manner in which users are enabled to provide voice messages as quick responses to incoming calls in one embodiment. Display area 1300 depicts a portion of the user interface displayed in client system 160A when an incoming call is received from another user. In particular, display area 1300 displays a list of pre-defined audio/voice messages that may be selected by the user. The description is continued assuming that the user has selected “I Will Call You Back” shown in display area 1325.

Display area 1350 depicts a portion of the user interface displayed in client system 160A when a user selects a desired voice/audio message to be provided as a quick response to an incoming call. Display area 1350 depicts the playing of the selected audio message I Will Call You Back” shown in display area 1325.

Thus, client app 150 enables voice messages to be provided as quick responses to incoming voice calls. Such a feature would specifically help those who are blind or cannot read the English language.

An additional challenge with the communications between client systems is that text messaging using conventional Short Message Service (SMS) has many drawbacks including inability to send an image or a video, size restrictions, carrier cost, delivery confirmation, read confirmation, encryption, inability to display Rich Text Formats, and the inability to validate requested user input. Multi-Media Messaging Service (MMS) provides image/video support and Mobile Instant Message (MIM) a smartphone-based push-notification protocol used by many of today's texting platforms overcomes many of the shortcomings including image/video support, cost, size, delivery/read confirmation, and encryption.

However, even the MIM protocol does not provide Rich Text Format support or input validation. For example, users of this MIM protocol cannot send formatted messages requiring user input with multiple choice boxes or input fields with data validation.

Business entities and consumers would like to send formatted text messages to enhance their messages. This might include but not limited to action buttons, option checkboxes, message encryption, two-factor authentication, and hyperlinks.

In addition, text message-based training/courseware is a growing industry. Currently, there are several courseware in the market using old SMS technology. There is a need to provide a fully automated courseware which can greatly enhance user experience.

Client app 150, according to an aspect of the present disclosure, provides a Rich Text messaging service that overcoming the drawbacks noted above. The manner in which client app 150 provides a rich text messaging service is described below with examples.

13. Rich Text Messaging Service

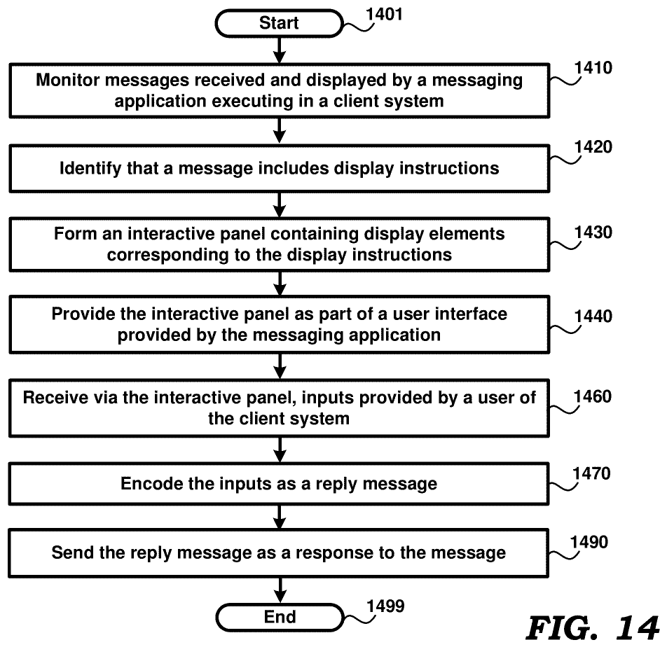

FIG. 14 is a flow chart illustrating the manner in which rich text messaging service is provided according to aspects of the present disclosure. The flowchart is described with respect to the systems of FIGS. 1, in particular client app 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 1401, in which control immediately passes to step 1410.

In step 1410, client app 150 monitors messages received and displayed by a messaging application executing in a client system (160A). In the following disclosure, the term “messaging application” refers to an application that uses MIM protocol to receive and send messages with other client systems (such as 160M) or server system 130.

In step 1420, client app 150 identifies that a (received) message includes display instructions. Such identification may entail inspecting the text of the received message to determine that the text contains pre-defined tags/symbols (for example, “<html>”) that indicate the presence of display instructions. In one embodiment described below, each message includes an indication which indicates whether the received message includes display instructions or not.

In step 1430, client app 150 forms an interactive panel containing display elements corresponding to the display instructions. Such forming may entail determining display elements (such as buttons, input boxes, etc.) specified by some display instructions, setting the determined display elements according to a layout (e.g., as a table, as flow, etc.) specified by other display instructions, and adding instructions (software code) to provide interactivity to the determined display elements (such as highlighting selected and a non-selected values using appropriate colors, etc.)

In step 1440, client app 150 provides the interactive panel as part of a user interface provided by the messaging application. Client app 150 may display the interactive panel as an overlay over the user interface of the messaging application. Alternatively, the interactive panel may be displayed as a separate screen but as part of the user interface as will be apparent to one skilled in the arts.

In step 1460, client app 150 receives via the interactive panel, inputs provided by a user of the client system. According to an aspect, client app 150 performs the validation of such inputs and may request different inputs if the inputs are deemed to be invalid. Different types of validations such as number validation, date validation, etc. may be performed by client app 150. Once valid inputs are received from the user, control passes to step 1470.

In step 1470, client app 150 encodes the inputs as a reply message. Such encoding may entail creating the reply message in accordance with the received message and the MIM protocol by adding additional information.

In step 1490, client app 150 sends the reply message as a response to the received message (identified in step 1420). The reply message may be sent to another client system (such as 160M) or server system 130 from which the message was received in step 1420. Control passes to step 1299, where the flowchart ends.

Thus, client app 150 provides a rich text messaging service. It should be appreciated that the Rich Text Messaging Service (RTMS) is a protocol that works on top of the MIM protocol to provide a rich text messaging ecosystem. Users of the RTMS protocol can configure and deliver interactive Rich Text Format (RTF) messages to smartphones (client systems 160A-160Z) providing rich user experience found in many web-based technologies.

Client app 150 processes the incoming messages according to the display instructions and presents an interactive panel to the user. If the message requires user response, client app 150 accepts user response according to formatting rules provided in the message. User data is then validated according to validation rules before sending a response back for the received message. If required, client app 150 also sends receipt confirmation and read confirmations for the received messages back to other client systems 160 or server system 130.

The manner in which client app 150 provides several aspects of the present disclosure according to the steps of FIG. 14 is described below with examples

### 14. Illustrative Example for Rich Text Messaging Service

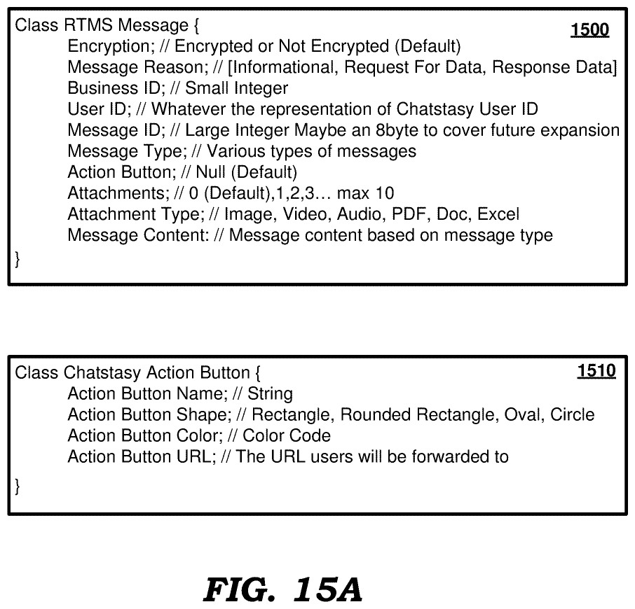

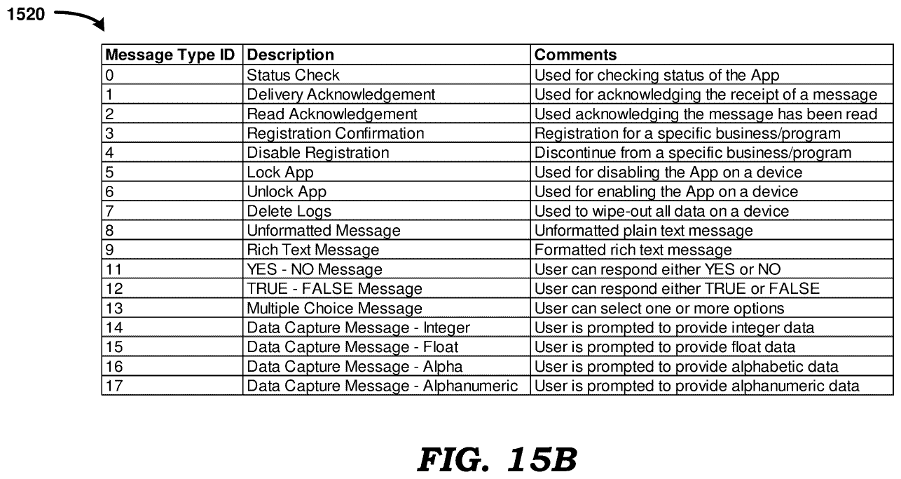

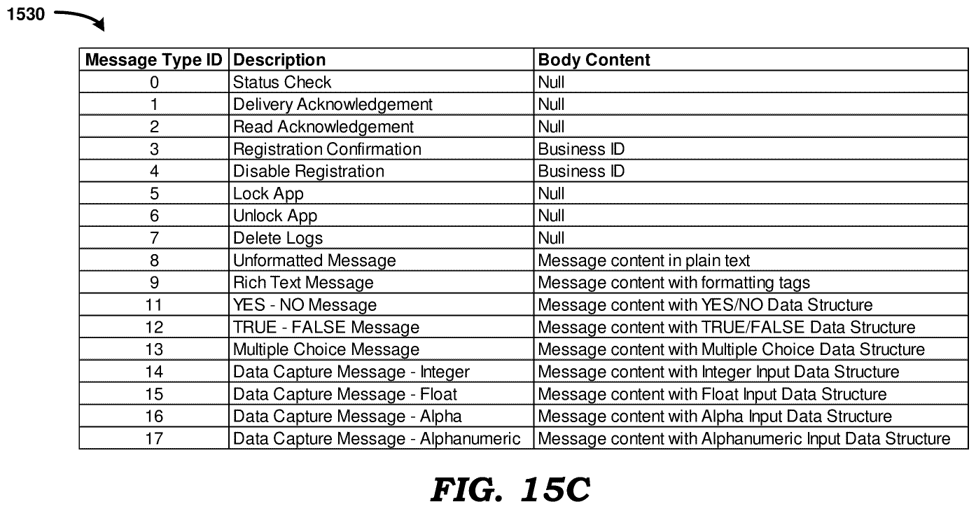

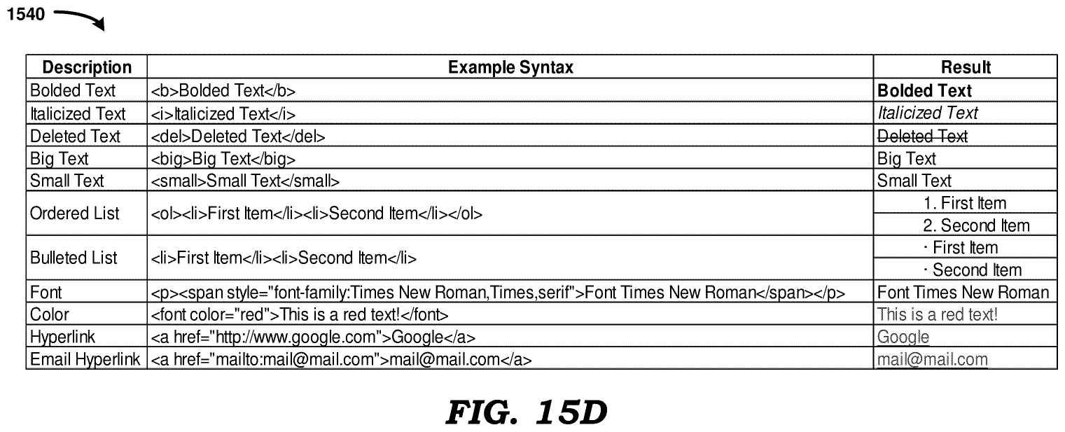

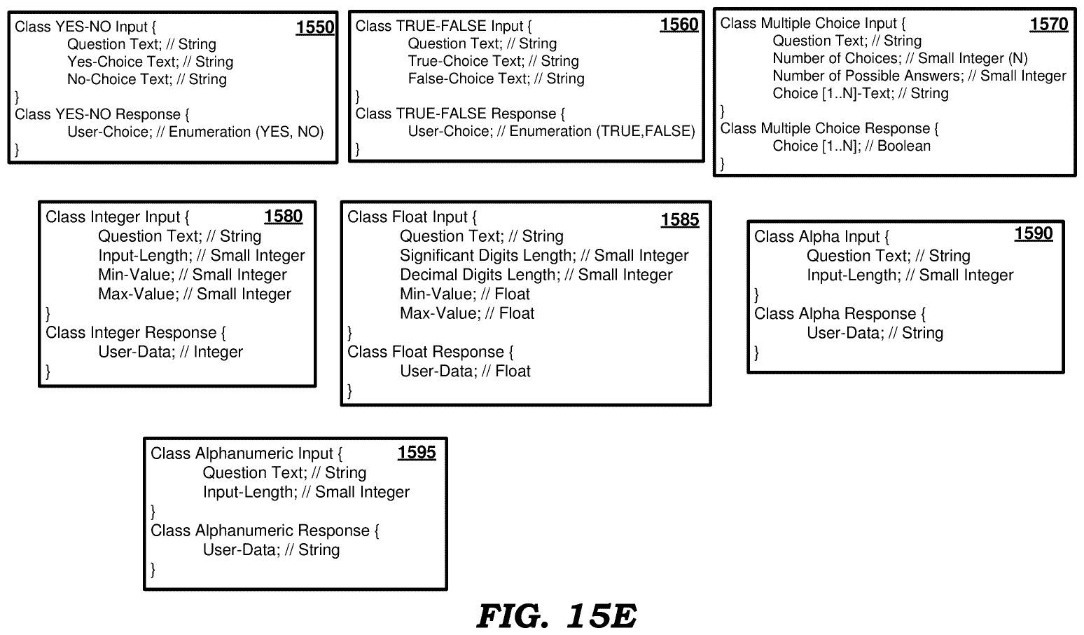

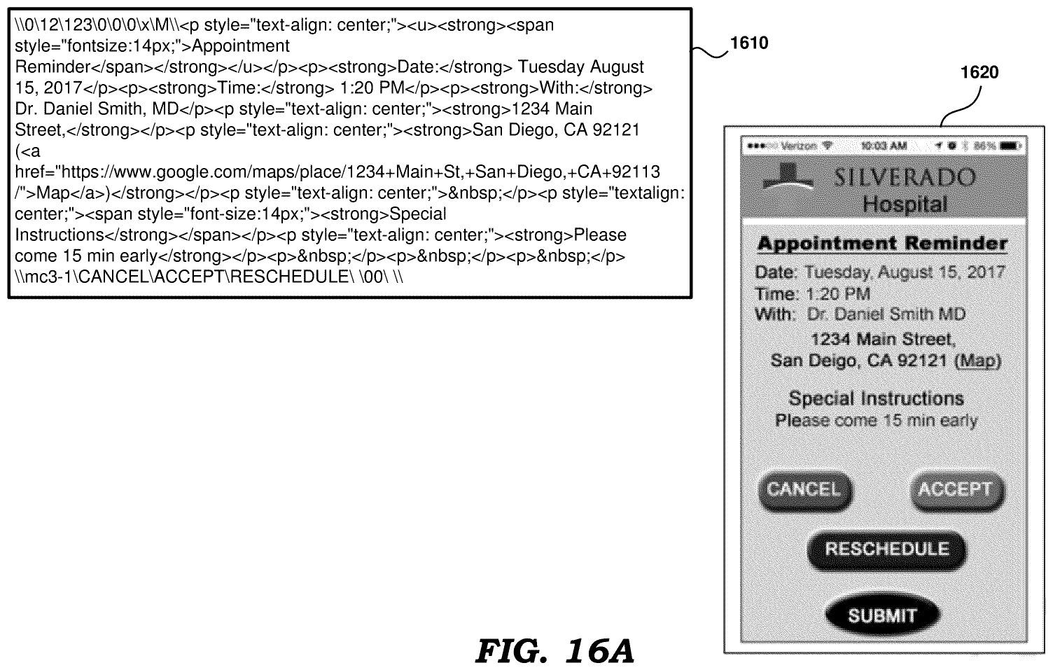

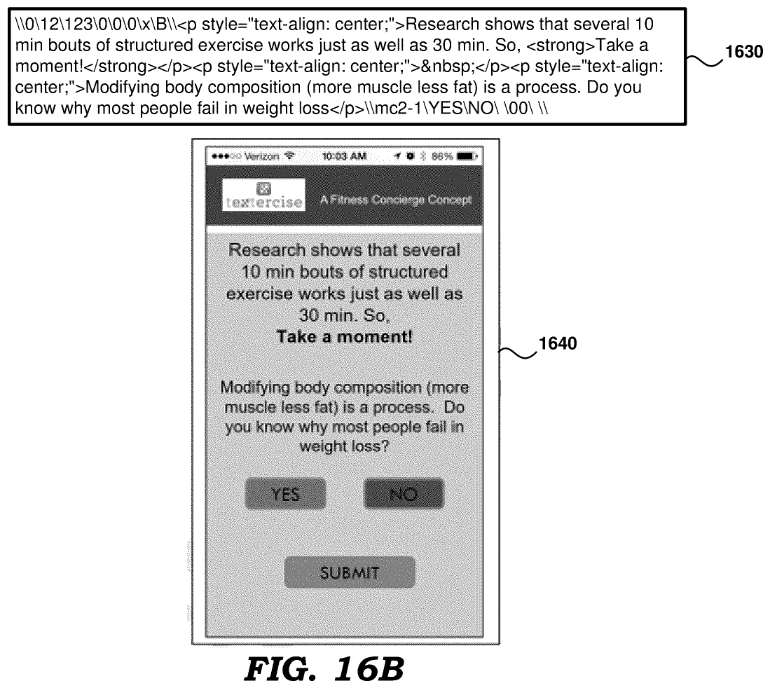

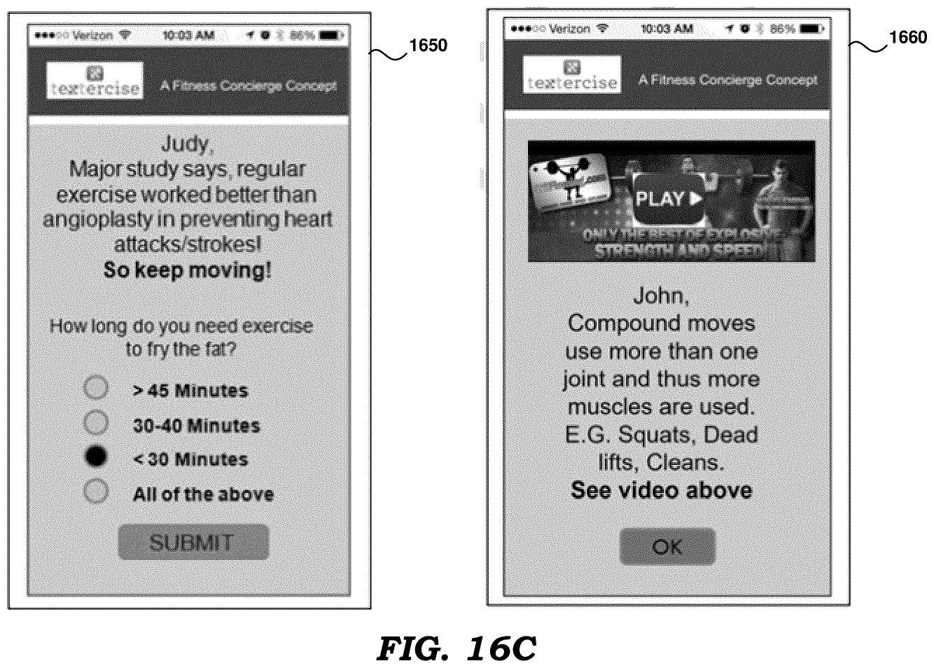

FIGS. 15A-15E and 16A-16C illustrate the manner in which a rich text messaging service is provided in one embodiment. Each of the Figures is described in detail below.

FIG. 15A-15E together depict the details of a rich text messaging service (RTMS) message in one embodiment. Referring to FIG. 15A, data portion 1500 depicts the overall structure of an RTMS message, and is shown containing an encryption flag indicating whether the message is encrypted is not, a message reason, a business entity identifier, a user identifier of said user, a message identifier, a message type, one or more action buttons, one or more attachments, an attachment type and a message content.

All RTMS messages have a message reason which indicates whether the message is a one-way origination message (Informational), a message requesting data (Request for Data), or the actual data received from a user (Response Data). All out-bound messages (messages that originate from server system 130) may have a unique message identifier. The message identifier may be used when client app 150 responds back to server system 130. For messages originating from client systems 160, the message identifier will be Null (blank). The server system may assign a unique identifier upon receiving the message.

RTMS messages may be of many message types as shown in table 1520 of FIG. 15B. Broadly, the message type is used indicate a type (status check, acknowledgement) of the message, to local/unlock client app 150 executing on client system 160A, to convey whether the message includes display instructions (rich text message) or not (unformatted message), to indicate whether the message requires any selection (YES/NO, TRUE/FALSE, Multiple Choice), and to indicate whether any data capture is required.

Each RTMS may include an action button, whose structure is shown in data portion 1510 of FIG. 15A. An action button may indicate a name, shape, color, and a universal resource locator (URL) associated with the button. Each RTMS message may also include one or more attachments which may be one of an image attachment (.jpg, .png, .gif), video attachment (.mp4), audio attachment (.mp3), document attachment (.pdf), document attachment (.doc) and document attachment (.xlx).

Message content field of data portion 1500 contains the actual message. The content can be of many formats as determined by the message type indicator. Some of the formats of the message content corresponding to different message types is shown in table 1530 of FIG. 15C. In one embodiment, the RTMS messages includes display instructions (tags) according to one of rich text format (RTF) and hypertext markup language (HTML). Some sample formatting tags that may be included in the message content is shown in table 1540 of FIG. 15D.

However, when the message type is indicating that the message requires selection and/or data capture, the message content is specific to the message type. FIG. 15E depicts the message content for several message types. For example, data portion 1550 depicts the message content (YES-NO Input) for a received RTMS message as well as the message content for the corresponding reply message (YES-NO Response). Similarly, data portions 1560 and 1570 depict the message contents for TRUE-FALSE and “Multiple Choice” message types.

Data portion 1580 depicts the message content when a data capture for an integer is to be performed. It may be observed the received message (Integer Input) specifies multiple validation rules—one for the input length, another for the minimum value that can be input, and one more for the maximum value that can be input. Such validation rules may be enforced when receiving inputs from the user. Data portions 1585, 1590 and 1595 depicts the message content (and also validation rules) for data capture of a float, an alphabet text and an alphanumeric text respectively.

Thus, RTMS messages containing desired display instructions may be intercepted (monitored and identified) by client app 150. In response to identifying an RTMS message, client app 150 forms and provides (displays) an interactive panel corresponding to the display instructions contained in the identified RTMS message as described below with examples.

FIGS. 16A-16C together illustrate sample rich text messaging service (RTMS) messages received at a client system and corresponding interactive panels provided on the client system. In FIG. 16A, data portion 1610 depicts an RTMS message, with display portion 1620 depicting the interactive panel provided by client app 150 corresponding to the display instructions contained in data portion 1610. Similarly, in FIG. 16B, display portion 1640 depicting the interactive panel provided by client app 150 corresponding to the display instructions contained in data portion 1630. In FIG. 16C, display portions 1650 and 1660 correspond to various interactive panels/user interfaces provided (displayed on a display unit associated with client system 160A) as part of a text message-based training/course ware.

It should be further appreciated that the features described above can be implemented in various embodiments as a desired combination of one or more of hardware, software, and firmware. The description is continued with respect to an embodiment in which various features are operative when the software instructions described above are executed.

15. Digital Processing System

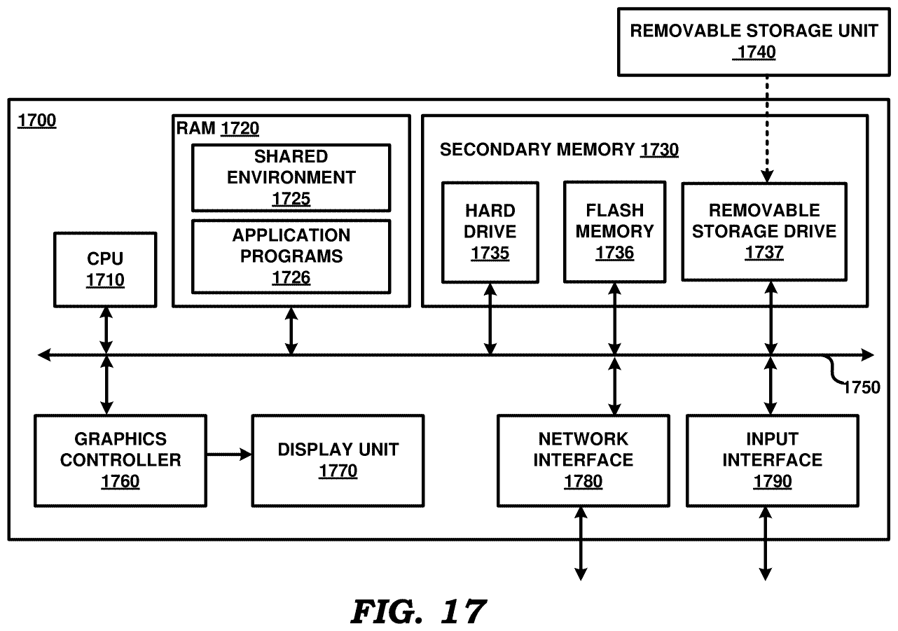

FIG. 17 is a block diagram illustrating the details of digital processing system (800) in which various aspects of the present disclosure are operative by execution of appropriate executable modules. Digital processing system 1700 may correspond to client app 150 or any system (e.g., client systems 160) implementing client app 150 or server system 130.

Digital processing system 1700 may contain one or more processors such as a central processing unit (CPU) 1710, random access memory (RAM) 1720, secondary memory 1730, graphics controller 1760, display unit 1770, network interface 1780, and input interface 1790. All the components except display unit 1770 may communicate with each other over communication path 1750, which may contain several buses as is well known in the relevant arts. The components of FIG. 17 are described below in further detail.

CPU 1710 may execute instructions stored in RAM 1720 to provide several features of the present disclosure. CPU 1710 may contain multiple processing units, with each processing unit potentially being designed for a specific task. Alternatively, CPU 1710 may contain only a single general-purpose processing unit.

RAM 1720 may receive instructions from secondary memory 1730 using communication path 1750. RAM 1720 is shown currently containing software instructions constituting shared environment 1725 and/or other user programs 1726 (such as other applications, DBMS, etc.). In addition to shared environment 1725, RAM 1720 may contain other software programs such as device drivers, virtual machines, etc., which provide a (common) run time environment for execution of other/user programs.

Graphics controller 1760 generates display signals (e.g., in RGB format) to display unit 1770 based on data/instructions received from CPU 1710. Display unit 1770 contains a display screen to display the images defined by the display signals (e.g., portions of the user interfaces shown in 4A-4G, 6A-6B, 9A-9H, 11A-11E, 13A-13B, 16A-16C). Input interface 1790 may correspond to a keyboard and a pointing device (e.g., touch-pad, mouse) and may be used to provide inputs (e.g., as required by the user interfaces shown in 4A-4G, 6A-6B, 9A-9H, 11A-11E, 13A-13B, 16A-16C). Network interface 1780 provides connectivity to a network (e.g., using Internet Protocol), and may be used to communicate with other systems connected to the networks.

Secondary memory 1730 may contain hard drive 1735, flash memory 1736, and removable storage drive 1737. Secondary memory 1730 may store the data (e.g., data shown in FIGS. 3, 8, and 15A-15E) and software instructions (e.g., for performing the actions of FIGS. 2, 5, 7, 10, 12, and 14, for implementing the various aspects of the present disclosure), which enable digital processing system 1700 to provide several features in accordance with the present disclosure. The code/instructions stored in secondary memory 1730 may either be copied to RAM 1720 prior to execution by CPU 1710 for higher execution speeds, or may be directly executed by CPU 1710.

Some or all of the data and instructions may be provided on removable storage unit 1740, and the data and instructions may be read and provided by removable storage drive 1737 to CPU 1710. Removable storage unit 1740 may be implemented using medium and storage format compatible with removable storage drive 1737 such that removable storage drive 1737 can read the data and instructions. Thus, removable storage unit 1740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1740 or hard disk installed in hard drive 1735. These computer program products are means for providing software to digital processing system 1700. CPU 1710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1730. Volatile media includes dynamic memory, such as RAM 1720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

16. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method performed at a client system, said method comprising:
receiving, an entity data specifying one or more phone numbers associated with a business entity and a logo of said business entity;
determining that a user using said client system has performed an action associated with at least one phone number of said one or more phone numbers; and
displaying, in response to said determining, said logo of said business entity on a display unit associated with said client system.

2. The method of claim 1, wherein said action comprises one of receiving/placing a voice call from/to said at least one phone number, wherein said displaying displays said logo during said voice call.

3. The method of claim 2, wherein said placing said voice call to said at least one phone number comprises:
providing on said display unit, a toggle button which in a first position causes a number keypad to be displayed on said display unit and in a second position causes a character keypad to be displayed on said display unit, wherein said number keypad enables said user to input one or more digits and said character keypad enables said user to input one or more characters, wherein each character in said character keypad has a mapping to a corresponding digit;
receiving via said number keypad a first set of digits and via said character keypad a first set of characters;
identifying a second set of digits corresponding to said first set of characters based on said mapping; and
constructing said at least one phone number by combining said first set of digits and said second set of digits.

4. The method of claim 1, wherein said action comprises viewing details of multiple business entities including said business entity, the method further comprising:
displaying one or more graphic buttons, wherein each graphic button, upon being selected, displays information about a corresponding business entity of said multiple business entities,
wherein said displaying displays the graphic button representing said business entity with said logo.

5. The method of claim 4, further comprising:
receiving a promotional graphics associated with said business entity; and
updating said graphic button representing said business entity to display said promotional graphics in place of said logo.

6. The method of claim 1, wherein said action comprises initiating a chat room between said user and said business entity, wherein said entity data also specifies a color associated with said business entity,
wherein said displaying comprises customizing said chatroom with said color and said logo of said business entity.

7. The method of claim 1, further comprising:
receiving calendar data specifying details of one or more time slots available in a business calendar of said business entity;
displaying on said display unit, an appointment widget showing the details of said one or more time slots;
receiving an indication to check conflicts whether said one or more time slots have any conflicts with appointments already made in a local calendar of said user;
determining, in response to said indication, conflicts between said one of more time slots and said appointments in said local calendar;
indicating, in said appointment widget, a status of said conflicts between said one or more time slots and said appointments, wherein said status comprises one of no conflict, partial conflict, and direct conflict;
receiving a confirmation from said user to add a new appointment in a first time slot of said one or more time slots; and
adding, in said response to said confirmation, said new appointment in said first time slot in said business calendar of said business entity and said local calendar of said user.

8. The method of claim 7, wherein each time slot of said one or more time slots is associated with a respective start time and a respective end time, said method further comprising:
receiving, via said appointment widget, a request for an earliest time slot available in said business calendar; and
identifying a time slot having the least respective start time that has no conflicts with said appointments as said earliest time slot.

9. The method of claim 7, wherein said calendar data also specifies a number of walk-ins allowable for a duration, said method further comprising:
receiving, via said appointment widget, a request for a walk-in in said duration;
identifying that said request is allowable in view of said number of walk-ins specified in said calendar data for said duration; and
adding, in response to said identifying, a walk-in appointment for said duration in said business calendar of said business entity and said local calendar of said user.

10. The method of claim 1, further comprising:
maintaining in said client system, a plurality of data elements related to said user;
receiving, from said user, an indication that a first data element of said plurality of data elements is to be provided access to a second user;
in response to said receiving said indication:
sending to a second client system used by said second user, the details of said first data element; and
enabling in said second client system, said second user to perform a second action related to said first data element,
wherein said receiving, said sending and said enabling is performed without receiving any communication from said second user.

11. The method of claim 10, wherein said first data element is a date associated with a personal event of said user, wherein said second action comprises placing a call or sending a greeting to said user.

12. The method of claim 10, wherein said first data element is an address associated with a location of said user, wherein said second action comprises providing to said second user, said address and directions to reach said address.

13. The method of claim 1, further comprising:
storing, in said client system, a set of voice messages provided by said user;
receiving an incoming call;
getting from said user, a selection of a first voice message from said set of voice messages; and
responding to said incoming call with said first voice message.

14. A method comprising:
monitoring, at a client system, messages received and displayed by a messaging application executing in said client system;
identifying, at said client system, that a first message of said messages includes one or more display instructions;
forming, at said client system, an interactive panel containing one or more display elements corresponding to said one or more display instructions;
providing, at said client system, said interactive panel as part of a user interface provided by said messaging application;
receiving, at said client system via said interactive panel, one or more inputs provided by a user of said client system;
encoding, at said client system, said one or more inputs as a first reply message; and
sending, by said client system, said first reply message as a response to said first message.

15. The method of claim 14, wherein each message comprises an encryption flag indicating whether the message is encrypted or not, a message reason, a business entity identifier, a user identifier of said user, a message identifier, a message type, one or more action buttons, one or more attachments, an attachment type and a message content.

16. The method of claim 15, wherein said message reason is one of one-way origination message, a message requesting data, or the actual data received from said user,
wherein each action button comprises a name, shape, color, and a universal resource locator (URL),
wherein said message content comprises said one or more display instructions according to one of rich text format (RTF) and hypertext markup language (HTML).

17. A non-transitory machine-readable medium storing one or more sequences of instructions, wherein execution of said one or more instructions by one or more processors contained in a client system cause said client system to perform the actions of:
receiving, an entity data specifying one or more phone numbers associated with a business entity and a logo of said business entity;
determining that a user using said client system has performed an action associated with at least one phone number of said one or more phone numbers; and
displaying, in response to said determining, said logo of said business entity on a display unit associated with said client system.

18. The non-transitory machine-readable medium of claim 17, further comprising one or more instructions for:
receiving calendar data specifying details of one or more time slots available in a business calendar of said business entity;
displaying on said display unit, an appointment widget showing the details of said one or more time slots;
receiving an indication to check conflicts whether said one or more time slots have any conflicts with appointments already made in a local calendar of said user;
determining, in response to said indication, conflicts between said one of more time slots and said appointments in said local calendar;
indicating, in said appointment widget, a status of said conflicts between said one or more time slots and said appointments, wherein said status comprises one of no conflict, partial conflict, and direct conflict;
receiving a confirmation from said user to add a new appointment in a first time slot of said one or more time slots; and
adding, in said response to said confirmation, said new appointment in said first time slot in said business calendar of said business entity and said local calendar of said user.

19. The non-transitory machine-readable medium of claim 17, further comprising one or more instructions for:
maintaining in said client system, a plurality of data elements related to said user;
receiving, from said user, an indication that a first data element of said plurality of data elements is to be provided access to a second user;
in response to said receiving said indication:
sending to a second client system used by said second user, the details of said first data element; and
enabling in said second client system, said second user to perform a second action related to said first data element,
wherein said receiving, said sending and said enabling is performed without receiving any communication from said second user.

20. The non-transitory machine-readable medium of claim 17, further comprising one or more instructions for:
storing, in said client system, a set of voice messages provided by said user;
receiving an incoming call;
getting from said user, a selection of a first voice message from said set of voice messages; and
responding to said incoming call with said first voice message.
